(19) United States
(12) Patent Application Publication
(10) Pub. No.: US 2024/0365187 A1
(43) Pub. Date: Oct. 31, 2024

(54) METHOD, USER EQUIPMENT, ACCESS NETWORK NODE, NODE FOR NON-TERRESTRIAL NETWORK ACCESS NETWORK

(71) Applicant: NEC Corporation, Minato-ku, Tokyo (JP)

(72) Inventor: Caroline LIANG, Guildford (GB)

(73) Assignee: NEC Corporation, Minato-ku, Tokyo (JP)

(21) Appl. No.: 18/292,463

(22) PCT Filed: Jul. 29, 2022
(86) PCT No.: PCT/JP2022/029249

§ 371 Date: Jan. 26, 2024

(30) Foreign Application Priority Data
Aug. 5, 2021 (GB) 2111337.8

(51) Int. Cl. H04W 36/06; H04W 36/00

(52) U.S. Cl. CPC H04W 36/06; H04W 36/0058

(57) ABSTRACT

A communication system is disclosed in which a user equipment (UE) receives, from a node of an access network, information for identifying an initial bandwidth part for communication between the UE and the access network in a first part of a communication coverage area provided by the access network, and information for identifying a set of one or more bandwidth parts, each bandwidth part of the set of bandwidth parts respectively being for potential future communication between the UE and the access network in a corresponding further part of the communication coverage area. A next bandwidth part of the set of bandwidth parts is identified, for switching to from the initial bandwidth part as a position of the UE relative to the communication coverage area enters, or approaches, the further part of the communication coverage area corresponding to the identified next bandwidth part.

### TECHNICAL FIELD

The present disclosure relates to a wireless communication system and devices thereof operating according to the 3rd Generation Partnership Project (3GPP) standards or equivalents or derivatives thereof. The disclosure has particular but not exclusive relevance to improvements relating to so-called ‘5G’ (or ‘Next Generation (NG)’ or ‘New Radio’ (NR)) systems in the context of Non-Terrestrial Networks (NTN).

### BACKGROUND ART

The latest developments of the 3GPP standards are the so-called ‘5G’ or ‘New Radio’ (NR) standards which refer to an evolving communication technology that is expected to support a variety of applications and services such as Machine Type Communications (MTC), Internet of Things (IoT)/Industrial Internet of Things (IIoT) communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, NPL 1.

End-user communication devices are commonly referred to as User Equipment (UE) which may be operated by a human or comprise automated (MTC/IoT) devices. Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). NPL 2 and NPL 3 define the following nodes, amongst others:
gNB: node providing NR user plane and control plane protocol terminations towards the UE and connected via the NG interface to the 5G core network (5GC).
ng-eNB: node providing Evolved Universal Terrestrial Radio Access (E-UTRA) user plane and control plane protocol terminations towards the UE and connected via the NG interface to the 5GC.
En-gNB: node providing NR user plane and control plane protocol terminations towards the UE and acting as Secondary Node in E-UTRA-NR Dual Connectivity (EN-DC).
NG-RAN node: either a gNB or an ng-eNB.

3GPP is also working with the satellite communication industry to specify an integrated satellite and terrestrial network infrastructure in the context of 5G.

This is referred to as Non-terrestrial networks (NTN) which term refers to networks, or segments of networks, using an airborne or spaceborne vehicle for transmission. Satellites refer to spaceborne vehicles in Low Earth Orbits (LEO), Medium Earth Orbits (MEO), Geostationary Earth Orbit (GEO) or in Highly Elliptical Orbits (HEO). Airborne vehicles refer to High Altitude Platforms (HAPs) encompassing Unmanned Aircraft Systems (UAS)—including tethered UAS, Lighter than Air UAS and Heavier than Air UAS—all operating quasi-stationary at an altitude typically between 8 and 50 km.

NPL 4 is a study on New Radio to support such non-terrestrial networks. The study includes, amongst other things, NTN deployment scenarios and related system parameters (such as architecture, altitude, orbit etc.) and a description of adaptation of the 3GPP channel models for non-terrestrial networks (propagation conditions, mobility, etc.). Non-terrestrial networks are expected to:
help foster the 5G service roll out in un-served or underserved areas to upgrade the performance of terrestrial networks;
reinforce service reliability by providing service continuity for user equipment or for moving platforms (e.g. passenger vehicles-aircraft, ships, high speed trains, buses);
increase service availability everywhere; especially for critical communications, future railway/maritime/aeronautical communications; and
enable 5G network scalability through the provision of efficient multicast/broadcast resources for data delivery towards the network edges or even directly to the user equipment.

Non-Terrestrial Network access typically features the following elements (amongst other things):
NTN Terminal: This may refer to the 3GPP UE or to a UE specific to the satellite system in the case that the satellite does not serve directly 3GPP UEs;
A service link which refers to the radio link between the user equipment and the space/airborne platform (which may be in addition to a radio link with a terrestrial based RAN);
A space or an airborne platform;
Gateways that connect the satellite or aerial access network to the core network. It will be appreciated that gateways will mostly likely be collocated with a base station (e.g. a gNB);
Feeder links which refer to the radio links between the Gateways and the space/airborne platform.

Satellite or aerial vehicles typically generate several satellite beams over a given area. The beams have a typically elliptic footprint on the surface of the earth. The beam footprint may be moving over the earth with the satellite or the aerial vehicle motion on its orbit. Alternatively, the beam footprint may be earth fixed (albeit temporarily), in such case some beam pointing mechanisms (mechanical or electronic steering feature) may be used to compensate for the satellite or the aerial vehicle motion.

The coverage in 5G is primarily beam-based rather than cell based. There is no cell-level reference channel from where the coverage of the cell could be measured. Instead, each cell has one or more so-called synchronization signal block (SSB) beams (which are different to satellite or NTN beams). SSB beams form a matrix of beams covering an entire cell area. Each SSB beam carries an SSB comprising a primary synchronization signal (PSS), secondary synchronization signal (SSS), and physical broadcast channel (PBCH).

The UE searches for and performs measurements on the SSB beams (e.g. of the synchronization signal reference signal received power, ‘SS-RSRP’, synchronization signal reference signal received quality, ‘SS-RSRQ’, and/or the synchronization signal signal to noise or interference ratio, ‘SS-SINR’). The UE maintains a set of candidate beams which may contain beams from multiple cells. A physical cell ID (PCI) and beam ID (or SSB index) thus distinguish the beams from each other. Effectively, therefore, the SSB beams are like mini cells which may be within a larger cell. Once a UE has detected and selected a cell (and/or an SSB beam in the case of 5G) it may attempt to access that cell and/or SSB beam using an initial radio resource control (RRC) connection setup procedure comprising a random-access procedure.

As communication technology has developed the maximum carrier bandwidth has grown (e.g. from 20 MHz in LTE to 400 MHz in NR). As the maximum bandwidth increases so do does the cost, in terms of power consumption, for a UE to scan the full bandwidth. Moreover, as cellular networks are required to support increasing numbers of UE types having varying capabilities, there are increasing numbers of device types that are incapable of communicating using the maximum carrier bandwidth.

This has led, in part, to the formulation of the concept of the bandwidth part (BWP) although it will be appreciated that the benefits provided by BWPs are not limited to more recent communication technology such as 5G.

3GPP is working on specifying enhancements for beam management and BWP operation for NTN. Beam level mobility (or ‘beam switching’) is dealt with at lower layers (PHY and MAC) without triggering additional Radio Resource Control (RRC) signalling overhead associated with the conventional handover procedure. Therefore, 3GPP prefers UE connected mode (e.g. layer 1, ‘L1’) mobility over handover-based mobility at least in case of multi-beam Earth moving cells. The currently proposed beam level mobility mechanism involves periodic Channel State Information Reference Signal (CSI-RS) transmissions by the base station and associated measurement reporting by the UE, especially in case of frequent beam switching. Issues related to beam switching have been extensively discussed in 3GPP meetings, however, no conclusions or agreements have been reached.

As the name suggests, a BWP comprises part of a total carrier bandwidth comprising a contiguous set of physical resource blocks, selected from a contiguous subset of the common resource blocks for a given numerology (μ), on a given carrier. Each BWP thus starts at a common resource block, spans over a set of consecutive common resource blocks within the carrier bandwidth, and is associated with its own numerology (i.e. corresponding to a specific sub-carrier spacing, ‘SCS’, and cyclic prefix, ‘CP’). Accordingly, even a UE that has the capability to use the maximum bandwidth may be configured to use a BWP with a narrow bandwidth during periods of relatively low communication activity and a wider bandwidth when there are large amounts of data to be transferred.

For each serving cell at least one downlink (DL) BWP and, if the serving cell is configured with an uplink (UL), at least one UL BWP. Currently, a UE can be configured with up to four DL BWPs and up to four UL BWPs for each serving cell. In case of supplementary uplink (SUL), there can be up to four additional uplink BWPs on the SUL carrier.

An initial DL BWP and an initial UL BWP are configured for at least an initial access procedure before a RRC connection is established. A UE uses an initial BWP when first accessing a cell. The initial DL BWP can be signalled within SIB1. The initial DL BWP parameter structure (e.g. defined by an InitialDLBWP information element) also specifies the subcarrier spacing for the BWP and provides the UE with cell level information for receiving the physical downlink control channel (PDCCH) and physical downlink shared channel (PDSCH). If the parameter structure is not provided to a UE then the initial DL BWP is defined by the set of Resource Blocks belonging to the CORESET #0. These Resource Blocks can be deduced from the master information block (MIB). Information regarding the initial UL BWP (e.g. defined by an InitialULBWP information element) can also be signalled within SIB1 or by dedicated signalling.

The DL and UL BWPs which are to be activated once an RRC connection is (re)established (e.g. on RRC configuration or reconfiguration following handover, secondary cell (SCell) addition, BWP switching or the like) are respectively known as the first active DL BWP and first UL BWP. The first active DL/UL BWP may be configured for a so-called special cell (SpCell) or a secondary cell (SCell). In a master cell group (MCG), the SpCell is the primary cell (PCell) in which the UE performs the connection establishment/re-establishment procedure. In a secondary cell group (SCG), the SpCell is the primary SCG cell (PSCell) in which the UE performs random access for RRC configuration/reconfiguration. An SCell provides additional radio resources to those provided by an SpCell in a cell group.

The network may also configure the UE with a BWP inactivity timer, expiry of which is indicative of the UE having no scheduled transmission or reception on the currently active BWP within a time period corresponding to the BWP inactivity timer. If the UE receives downlink control information (e.g. on a physical downlink control channel, ‘PDCCH’) that schedules the DL or UL, the inactivity timer (re)starts. If there is no additional scheduling command before the expiration of timer, the UE will perform BWP switching to fall back to using a default DL BWP. The default DL BWP may be configured by the network but, typically, where no default DL BWP is explicitly configured, the UE will fall back to using the initial DL BWP as the default DL BWP.

Even though multiple BWPs can be defined in the DL and/or UL, currently only one BWP can be active at a time in each direction (DL and UL). Accordingly, current systems implement a BWP switching (or ‘selection’) mechanism to allow a specific BWP to be selected as the active BWP for communication. Currently BWP switching may be triggered in a number of different ways including:
Using downlink control information (DCI) transmitted to the UE in a downlink control channel (e.g. the PDCCH). For example, a specific BWP can be activated by the so called ‘bandwidth part indicator’ field or information element (IE) in a DCI UL grant format (e.g. DCI format 0_1 for scheduling of a physical uplink shared channel, ‘PUSCH’, in a cell) and/or a DCI DL scheduling format (e.g. DCI Format 1_1 for scheduling of a physical downlink shared channel, ‘PDSCH’, in a cell);
Using a timer to trigger BWP switching back to the original (initial) or default DL BWP after a period of inactivity. For example, using the BWP inactivity timer (e.g. defined by a bwp-InactivityTimer IE) which may be provided in a serving cell configuration (e.g. defined by a ServingCellConfig IE) according to NPL 5;
Using radio resource control (RRC) signalling; and/or
Using a medium access control (MAC, also known media access control) control element (CE) itself upon initiation of a random access procedure.

### CITATION LIST

### Non Patent Literature

NPL 1: the ‘NGMN 5G White Paper’ V1.0, Next Generation Mobile Networks (NGMN) Alliance, <https://www.ngmn.org/5g-white-paper.html>
NPL 2: 3GPP TS 38.300 V16.3.0
NPL 3: 3GPP TS 37.340 V16.3.0
NPL 4: 3GPP TR 38.811 V15.4.0
NPL 5: 3GPP TS 38.331 V16.5.0

### SUMMARY OF INVENTION

### Technical Problem

The development of support for NTNs has, however, led to a need for enhancements for beam management and bandwidth parts (BWP) operation for NTN with frequency reuse.

In current NR systems, for example, dynamic BWP switching requires data scheduling. However, data scheduling slows down BWP switching and for NTN scenarios (especially with frequency reuse factors, ‘FRF’, greater than 1) faster BWP switching triggering (e.g. without data scheduling may be desirable).

Moreover, in low Earth orbit (LEO) scenarios with satellite originating beams moving relative to the Earth, it may no longer be feasible for the UE to fall back to the original initial BWP upon timer expiry (due to satellite velocity, the Earth moving, and the large propagation delay in NTN). Furthermore, the satellite cell has a large coverage footprint of tens or even hundreds of kilometres, meaning that the common initial BWP can become congested or blocked if the number of users becomes large. The need to switch out of the initial BWP can become frequent and, if a UE keeps switching back to the original initial (or other default) BWP (e.g. as indicated by defaultDownlinkBWP-Id), it may cause unnecessary delay or even radio link failure.

Currently when the network re-configures a new BWP, it has an associated new configuration, for example a PDCCH configuration (pdcch-Config), PDSCH configuration (pdsch-Config), semi-persistent scheduling configuration (sps-Config), radio link monitoring configuration (radioLinkMonitorConfig) etc. In the context of NTN where a UE is effectively switching from one beam (or cell) to another as the satellite moves relative to the earth, such configuration of new BWPs has the potential to become inefficient.

There is also a need to consider how to efficiently deal with BWP switching triggered by the inactivity timer.

Moreover, in NTN networks, neighbouring cells or beams may use different polarization modes (e.g. right-hand circular polarization, ‘RHCP’, left-hand circular polarization, ‘LHCP’, or linear polarization) to mitigate inter-cell interference. Furthermore, there may be UEs with different antenna types. Some UEs may be equipped with linearly polarized antennas, while some other UEs may be equipped with circularly polarized antennas.

For an operation with fixed polarization per cell/beam, a UE may switch polarization for reception of SSB (for initial access) and adopt SSB with larger reception power when both polarizations are detected. However, such blind detection represents additional UE complexity and processing delay for SSB detection. Furthermore, if UE detects wrong polarization and transmits uplink data with the wrong polarization, it may cause severe inter-cell/beam interference. Therefore, it is desirable to explicitly notify information on polarization to the UE.

Accordingly, the present disclosure seeks to provide methods and associated apparatus that address or at least alleviate (at least one or more of) the above-described issues.

### Solution to Problem

Although for efficiency of understanding for those of skill in the art, the disclosure will be described in detail in the context of a 3GPP system (5G networks including NTN), the principles of the disclosure can be applied to other systems as well.

Aspects of the disclosure are set out in the appended independent claims optional but beneficial features are set out in the appended dependent claims.

In one aspect there is provided a method performed by a user equipment (UE) in a communication system, the method comprising: receiving, from a node of an access network, information for identifying an initial bandwidth part for communication between the UE and the access network in a first part of a communication coverage area provided by the access network, and information for identifying a set of one or more bandwidth parts, each bandwidth part of the set of bandwidth parts respectively being for potential future communication between the UE and the access network in a corresponding further part of the communication coverage area; identifying a next bandwidth part of the set of bandwidth parts, for switching to from the initial bandwidth part as a position of the UE relative to the communication coverage area enters, or is approaching, the further part of the communication coverage area corresponding to the identified next bandwidth part; and switching to the identified next bandwidth part.

In one aspect there is provided a method performed by a user equipment (UE) in a communication system, the method comprising: receiving, from a node of a non-terrestrial network (NTN) access network, information identifying at least one polarization employed by the NTN access network for communication in at least part of a communication coverage area provided by the NTN access network; communicating with the NTN access network based on the information identifying at least one polarization employed by the access network; and receiving, from the node of the NTN access network, ephemeris information for a satellite of the NTN access network, wherein updates to the ephemeris information are received at a first periodicity; wherein updates to the information identifying at least one polarization employed by the access network are received at a second periodicity corresponding to the first periodicity at which the updates to the ephemeris information are received.

In one aspect there is provided a method performed by a user equipment (UE) in a communication system, the method comprising: providing, to a node of a non-terrestrial network (NTN) access network, UE capability information comprising a capability indication for indicating a polarization capability of the UE, the capability indication for indicating a polarization capability being configurable for indicating the polarization capability to be any one of: a linear polarization capability; a right-hand circular polarization capability; a left-hand circular polarization capability; and both a right-hand circular polarization capability and a left-hand circular polarization capability.

In one aspect there is provided a method performed by a node of an access network in a communication system, the method comprising: providing, to a user equipment (UE), information for identifying an initial bandwidth part for communication between the UE and the access network in a first part of a communication coverage area provided by the access network, and information for identifying a set of one or more bandwidth parts, each bandwidth part of the set of bandwidth parts respectively being for potential future communication between the UE and the access network in a corresponding further part of the communication coverage area. The node of an access network may identify a next bandwidth part of the set of bandwidth parts, for the UE to switch to from the initial bandwidth part as a position of the UE relative to the communication coverage area enters, or is approaching, the further part of the communication coverage area corresponding to the identified next bandwidth part. The node of an access network may identify when the UE has switched to the identified next bandwidth part.

In one aspect there is provided a method performed by a node of a non-terrestrial network (NTN) access network in a communication system, the method comprising: providing, to a user equipment (UE), information identifying at least one polarization employed by the NTN access network for communication in at least part of a communication coverage area provided by the NTN access network; communicating with the UE based on the at least one polarization employed by the access network; and providing, to the UE, ephemeris information for a satellite of the NTN access network, wherein updates to the ephemeris information are provided at a first periodicity; wherein updates to the information identifying at least one polarization employed by the access network are provided at a second periodicity corresponding to the first periodicity at which the updates to the ephemeris information are provided.

In one aspect there is provided a method performed by a node of a non-terrestrial network (NTN) access network in a communication system, the method comprising: receiving, from a UE, UE capability information comprising a capability indication for indicating a polarization capability of the UE, the capability indication for indicating a polarization capability being configurable for indicating the polarization capability to be any one of: a linear polarization capability; a right-hand circular polarization capability; a left-hand circular polarization capability; and both a right-hand circular polarization capability and a left-hand circular polarization capability.

In one aspect there is provided a user equipment (UE) for a communication system, the UE comprising: a controller and a transceiver, wherein the controller is configured to: control the transceiver to receive, from a node of an access network, information for identifying an initial bandwidth part for communication between the UE and the access network in a first part of a communication coverage area provided by the access network, and information for identifying a set of one or more bandwidth parts, each bandwidth part of the set of bandwidth parts respectively being for potential future communication between the UE and the access network in a corresponding further part of the communication coverage area; identify a next bandwidth part of the set of bandwidth parts, for switching to from the initial bandwidth part as a position of the UE relative to the communication coverage area enters, or is approaching, the further part of the communication coverage area corresponding to the identified next bandwidth part; and control the transceiver to switch to the identified next bandwidth part.

In one aspect there is provided a user equipment (UE) for a communication system, the UE comprising: a controller and a transceiver, wherein the controller is configured to: control the transceiver to receive, from a node of a non-terrestrial network (NTN) access network, information identifying at least one polarization employed by the NTN access network for communication in at least part of a communication coverage area provided by the NTN access network; control the transceiver to communicate with the NTN access network based on the information identifying at least one polarization employed by the access network; and control the transceiver to receive, from the node of the NTN access network, ephemeris information for a satellite of the NTN access network, wherein updates to the ephemeris information are received at a first periodicity; wherein updates to the information identifying at least one polarization employed by the access network are received at a second periodicity corresponding to the first periodicity at which the updates to the ephemeris information are received.

In one aspect there is provided a user equipment (UE) for a communication system, the UE comprising: a controller and a transceiver, wherein the controller is configured to: control the transceiver to provide, to a node of a non-terrestrial network (NTN) access network, UE capability information comprising a capability indication for indicating a polarization capability of the UE, the capability indication for indicating a polarization capability being configurable for indicating the polarization capability to be any one of: a linear polarization capability; a right-hand circular polarization capability; a left-hand circular polarization capability; and both a right-hand circular polarization capability and a left-hand circular polarization capability.

In one aspect there is provided an access network node for a communication system, the access network node comprising: a controller and a transceiver, wherein the controller is configured to: control the transceiver to provide, to a user equipment (UE), information for identifying an initial bandwidth part for communication between the UE and the access network in a first part of a communication coverage area provided by the access network, and information for identifying a set of one or more bandwidth parts, each bandwidth part of the set of bandwidth parts respectively being for potential future communication between the UE and the access network in a corresponding further part of the communication coverage area. The controller may be configured to identify a next bandwidth part of the set of bandwidth parts, for the UE to switch to from the initial bandwidth part as a position of the UE relative to the communication coverage area enters, or is approaching, the further part of the communication coverage area corresponding to the identified next bandwidth part. The controller may be configured to identify when the UE has switched to the identified next bandwidth part.

In one aspect there is provided a node for a non-terrestrial network (NTN) access network, the node comprising: a controller and a transceiver, wherein the controller is configured to: control the transceiver to provide, to a user equipment (UE), information identifying at least one polarization employed by the NTN access network for communication in at least part of a communication coverage area provided by the NTN access network; control the transceiver to communicate with the UE based on the at least one polarization employed by the access network; and control the transceiver to provide, to the UE, ephemeris information for a satellite of the NTN access network, wherein updates to the ephemeris information are provided at a first periodicity; wherein updates to the information identifying at least one polarization employed by the access network are provided at a second periodicity corresponding to the first periodicity at which the updates to the ephemeris information are provided.

In one aspect there is provided a node for a non-terrestrial network (NTN) access network, the node comprising: a controller and a transceiver, wherein the controller is configured to: control the transceiver to receive, from a UE, UE capability information comprising a capability indication for indicating a polarization capability of the UE, the capability indication for indicating a polarization capability being configurable for indicating the polarization capability to be any one of: a linear polarization capability; a right-hand circular polarization capability; a left-hand circular polarization capability; and both a right-hand circular polarization capability and a left-hand circular polarization capability.

Aspects of the disclosure extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the disclosure independently of (or in combination with) any other disclosed and/or illustrated features where it is technically feasible to do so. In particular, but without limitation, the features of any of the claims dependent from a particular independent claim may be introduced into that independent claim in any combination or individually wherever doing so does not cause a technically incompatibility or result in something that does not make technical sense.

### BRIEF DESCRIPTION OF DRAWINGS

Embodiments of the disclosure will now be described, by way of example, with reference to the accompanying drawings in which:

FIG. 1 illustrates schematically a mobile (cellular or wireless) telecommunication system to which embodiments of the disclosure may be applied;

FIG. 2A respectively illustrate a possible mapping between a physical cell identity (PCI) and synchronization signal block (SSB) beam(s);

FIG. 2B respectively illustrate a possible mapping between a physical cell identity (PCI) and synchronization signal block (SSB) beam(s);

FIG. 3A illustrate a respective SSB beam configuration options for bandwidth parts (BWPs) in a satellite cell for the system of FIG. 1;

FIG. 3B illustrate a respective SSB beam configuration options for bandwidth parts (BWPs) in a satellite cell for the system of FIG. 1;

FIG. 4A respectively illustrate a possible implementation of an access network that may be used in the system of FIG. 1;

FIG. 4B respectively illustrate a possible implementation of an access network that may be used in the system of FIG. 1;

FIG. 4C respectively illustrate a possible implementation of an access network that may be used in the system of FIG. 1;

FIG. 5 is a simplified block schematic illustrating the main components of a user equipment that may be used in the system of FIG. 1;

FIG. 6 is a simplified block schematic illustrating the main components of a base station that may be used in the system of FIG. 1;

FIG. 7 is a simplified block schematic illustrating the main components of a base station of a distributed type that may be used in the system of FIG. 1;

FIG. 8 is a simplified flow diagram illustrating a configured BWP switching procedure that may be used in the system of FIG. 1;

FIG. 9 is a simplified flow diagram illustrating a measurement-based BWP switching procedure that may be used in the system of FIG. 1;

FIG. 10 is a simplified flow diagram illustrating a procedure for providing a UE with polarization information that may be used in the system of FIG. 1; and

FIG. 11 is a simplified flow diagram illustrating a procedure for providing a base station with an indication of a UE's polarization capability that may be used in the system of FIG. 1.

### DESCRIPTION OF EMBODIMENTS

### Overview

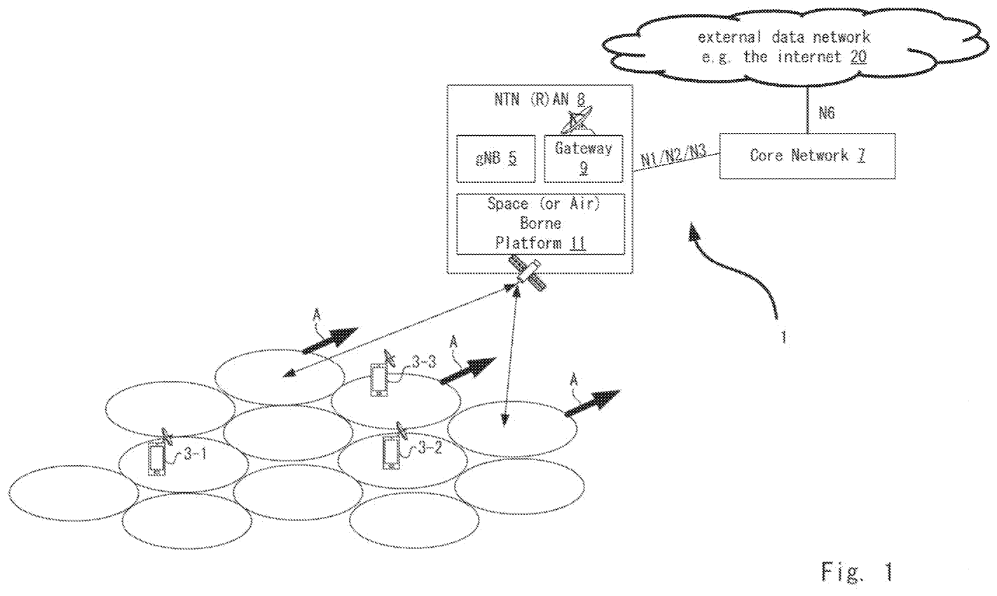

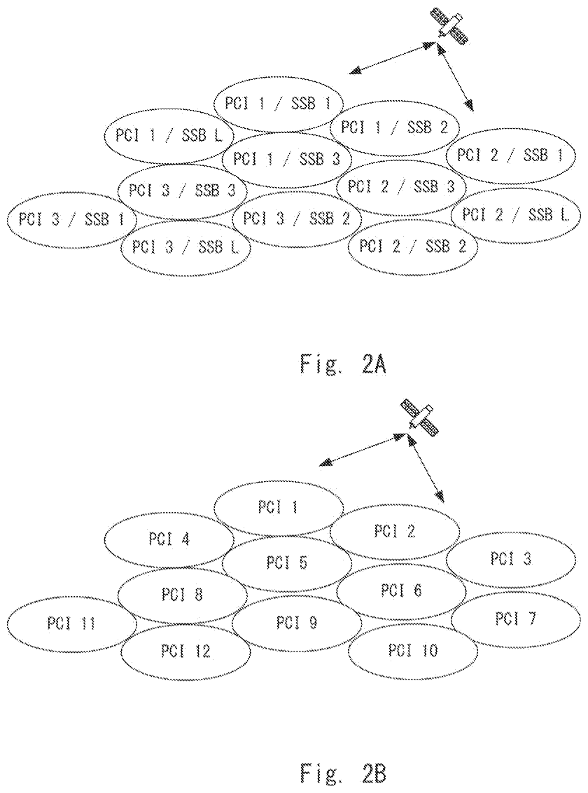

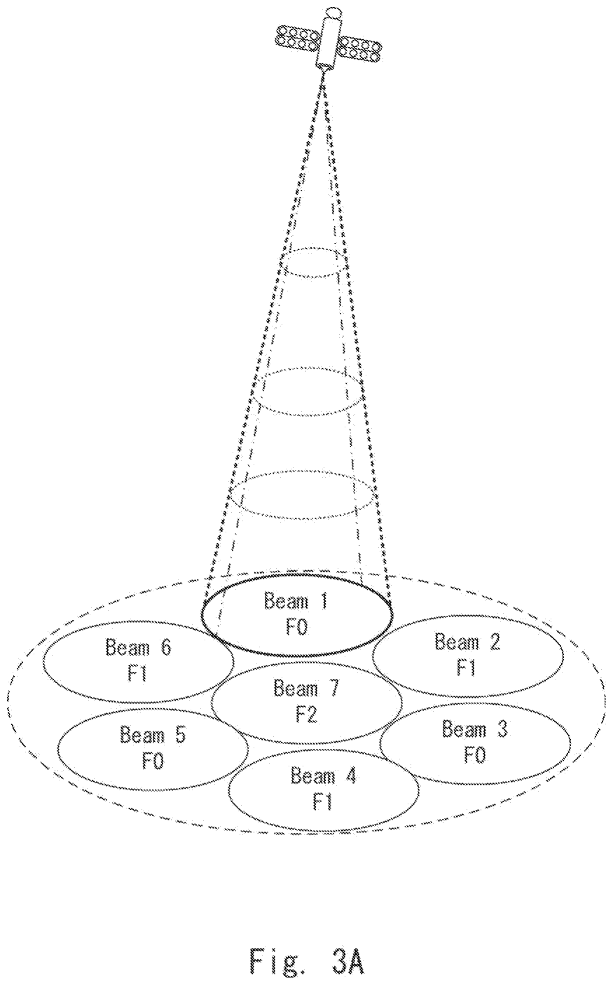

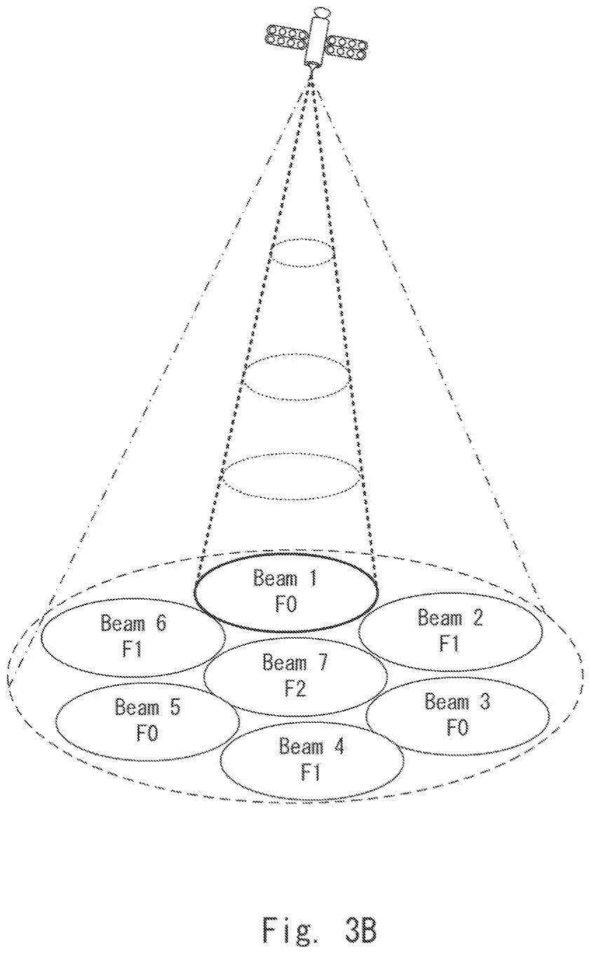

Referring to FIGS. 1 to 3, FIG. 1 illustrates schematically a mobile (cellular or wireless) communication system 1 to which embodiments of the disclosure may be applied. FIGS. 2A and 2B each respectively illustrate a possible mapping between a physical cell identity (PCI) and synchronization signal block (SSB) beam(s). FIGS. 3A and 3B each illustrate a respective SSB beam configuration options for bandwidth parts (BWPs) in a satellite cell for the system of FIG. 1.

In this system 1, users of items of user equipment (UEs) 3-1, 3-2, 3-3 (e.g. mobile telephones and/or other mobile devices) can communicate with each other and/or other user equipment via a non-terrestrial network (NTN) radio access network (RAN) 8 that operates according to one or more compatible radio access technologies (RATs) for example, an E-UTRA and/or 5G RAT. In the illustrated example, the NTN RAN comprises a base station or ‘gNB’ 5 operating one or more associated cells, a gateway 9, and a non-terrestrial (space or air borne) platform 11 (e.g. comprising one or more satellites and/or airborne vehicles), which may be referred to generally as a ‘satellite’ for simplicity. Communication via the NTN RAN 8 is typically routed through a core network 7 (e.g. a 5G core network or evolved packet core network (EPC)) and one or more external data networks 20 (e.g. via an N6 interface/reference point or the like).

As those skilled in the art will appreciate, whilst three UEs 3 and one NTN RAN 8 comprising one base station 5, one gateway 9 and one non-terrestrial platform 11, are shown in FIG. 1 for illustration purposes, the system, when implemented, will typically include any number of UEs, other RANs (both terrestrial and non-terrestrial), NTN platforms, base stations, gateways, UEs etc.

Although not shown in FIG. 1, neighbouring base stations 5 are connected to each other via an appropriate base station to base station interface (such as the so-called ‘X2’ interface, ‘Xn’ interface and/or the like). The base station 5 is also connected to the core network nodes via appropriate interfaces.

The core network 7 (e.g. the EPC in case of LTE or the NGC in case of NR/5G) typically includes logical nodes (or ‘functions’) for supporting communication in the communication system 1, and for subscriber management, mobility management, charging, security, call/session management (amongst others). For example, the core network 7 of a ‘Next Generation’/5G system will include user plane entities and control plane entities, such as one or more control plane functions (CPFs) and one or more user plane functions (UPFs). The so-called Access and Mobility Management Function (AMF) in 5G, or the Mobility Management Entity (MME) in 4G, is responsible for handling connection and mobility management tasks for the mobile devices 3.

Each NTN RAN 8 controls a number of directional satellite beams via which associated NTN cells may be provided. Specifically, each satellite beam has an associated footprint on the surface of the Earth which forms an NTN cell, or part of an NTN cell. Each NTN cell has an associated Physical Cell Identity (PCI). The satellite beam footprints may be moving as the space (or air) borne platform 11 is travelling along its orbit (e.g. as illustrated by the arrows A in FIG. 1). Alternatively, the satellite beam footprint may be earth fixed, in which case an appropriate satellite beam pointing mechanism (mechanical or electronic steering) may be used to compensate for the movement of the satellite 11. Satellite beams and satellites are not considered visible from UE perspective in NTN. This does not, however, preclude differentiating at the PLMN level the type of network (e.g. NTN vs. terrestrial).

The NTN RAN 8 is configured to provide ephemeris data for the satellite 11, to the UEs 3, to help UEs perform measurement and cell selection/reselection and for supporting initial access. This ephemeris data may comprise information on orbital information such as information on orbital plane level or on satellite level and/or information (e.g. a pointer or index) from which more detailed ephemeris data stored in the UE3 (e.g. in a subscriber identity module, ‘SIM’) may be obtained. At least some of this ephemeris information may, for example, be provided in system information and/or may be provided using UE specific (dedicated) signalling such as RRC signalling.

With the help of this ephemeris data, a UE 3 may search for the first NTN cell it can connect to. After detecting an SSB of a cell broadcasted by a satellite, the UE may be able to read initial system information of that cell which may contain further ephemeris information relating to the exact location of the cell (and/or to the satellite broadcasting the cell). This ephemeris information may be given relative to information relating, for example, to the orbital plane that the UE 3 may already have obtained.

The accuracy of the prediction of a satellite orbit or the satellite position can decrease with time and so, to help ensure accuracy, the ephemeris data provided to the UE 3 is updated periodically.

The same PCI may be used for several satellite beams, or there may be one PCI per satellite beam. A satellite beam can consist of one or more SSB beams with one cell (PCI) having a maximum of L SSB beams, where L can typically be 4, 8 or 64 depending on the band. During initial access, the UEs 3 perform cell search based on SSBs where each SSB is transmitted in a different respective beam. Each SSB comprises a primary synchronization signal (PSS), secondary synchronization signal (SSS), and physical broadcast channel (PBCH). As the SSB carries synchronization signals (SSs)/PBCH (SS/PBCH) transmissions it is sometimes referred to as an SS/PBCH block.

As seen in FIGS. 2A and 2B the communication system 1 can also implement different options for the relationship between the PCI and the SSB beams. In the option illustrated in FIG. 2A there are multiple SSB beams (SSB 1 . . . SSB L) for each PCI. Contrastingly, in the option illustrated in FIG. 2B there is a one-to-one mapping between each SSB beam and a respective PCI meaning that there is effectively a single SSB beam per NTN cell. Both these options are supported by current 3GPP specifications for NR-NTN.

Each cell has an associated ‘NR Cell Global Identifier’ (NCGI) to identify the cell globally. The NCGI is constructed from the Public Land Mobile Network (PLMN) identity (PLMN ID) the cell belongs to and the NR Cell Identity (NCI) of the cell. The PLMN ID included in the NCGI is the first PLMN ID within the set of PLMN IDs associated to the NR Cell Identity in System Information Block Type 1 (SIB1). The ‘gNB Identifier’ (gNB ID) is used to identify a particular gNB within a PLMN. The gNB ID is contained within the NCI of its cells. The ‘Global gNB ID’ is used to identify a gNB globally and it is constructed from the PLMN identity the gNB belongs to and the gNB ID. The Mobile Country Code (MCC) and Mobile Network Code (MNC) are the same as included in the NCGI.

The UEs 3 and RAN equipment 8 of the communication system 1 are configured for operation using bandwidth parts (BWPs) that each start at a respective common resource block (RB) and respectively comprises of a set of contiguous RBs with a given numerology (sub-carrier spacing, ‘SCS’, and cyclic prefix, ‘CP’) on a given carrier. For each serving cell of a UE 3, the RAN equipment 8 (e.g. the base station 5) can configure at least one downlink (DL) BWP (e.g. an initial DL BWP). The RAN equipment 8 may configure the UE 3 with up to a maximum (typically four) DL BWPs with only a single DL BWP being active at a given time.

Where the serving cell is configured with an uplink (UL), the RAN equipment 8 can configure at least one UL BWP (e.g. an initial UL BWP). The RAN equipment 8 may configure the UE 3 with up to a maximum (typically four) UL BWPs with only one UL BWP being active at a given time. The communication system 1 of this example also supports a supplementary UL (SUL), on which an additional set of one or more UL BWP(s) can also be configured (e.g. up to a maximum of four SUL BWPs) as for the ‘normal’ UL carrier. This provides for potentially twice as many UL BWPs (typically a maximum of eight UL BWPs).

Specifically, the RAN equipment 8 is able to configure an initial DL BWP (e.g. by means of an initialDownlinkBWP IE) via system information (e.g. system information block 1, ‘SIB1’) and/or via dedicated (e.g. RRC) signalling (e.g. an RRC reconfiguration, RRC resume, or RRC setup message). For example, the common parameters for the initial DL BWP may be provided via system information whereas UE specific parameters may be provided via dedicated signalling (e.g. in a ServingCellConfig IE within an RRC message that contains a dedicated, UE-specific, BWP configuration). The dedicated signalling may also contain some cell-specific information which may be useful for specific scenarios (e.g. handover).

The RAN equipment 8 is able to configure an initial UL BWP (e.g. by means of an initialUplinkBWP IE) via system information (e.g. system information block 1, ‘SIB1’) and/or via dedicated (e.g. RRC) signalling (e.g. an RRC reconfiguration, RRC resume, or RRC setup message). Where there an SUL is configured an additional initial BWP may be configured. For example, the common parameters for the initial UL BWP(s) may be provided via system information whereas UE specific parameters may be provided via dedicated signalling (e.g. in a ServingCellConfig IE within an RRC message that contains a dedicated, UE-specific, BWP configuration). This provides configuration information either for a so-called special cell (SpCell)—which is a PCell of a master cell group (MCG) or secondary cell group (SCG)—or a secondary cell (SCell).

The initial DL and UL BWPs are used at least for initial access before an RRC connection is established. The initial BWP is known as BWP #0 as it has a BWP identifier (or ‘index’) of zero. Prior to receiving system information defining a UE's initial DL BWP, the DL BWP for each UE 3 has a frequency range and numerology corresponding to a control resource set (CORESET)—e.g. CORESET #0—defined by a master information block (MIB) (or possibly dedicated RRC signalling). The CORESET is used to carry downlink control information (DCI) transmitted via a physical downlink control channel (PDCCH) for scheduling system information blocks.

After receiving the system information (e.g. SIB1) a UE 3 uses the BWP configuration defined by that system information to configure the initial DL BWP and initial UL BWP. The configured initial UL BWP is then used to initiate a random-access procedure for setting up an RRC connection. The RAN 8 configures the frequency domain location and bandwidth of the initial DL BWP in the SIB1 so that the initial DL BWP contains the entire CORESET #0 in the frequency domain.

As seen in FIGS. 3A and 3B the communication system 1 can also implement different BWP beam layout options. In FIG. 3A the initial BWP (BWP #0) carrying the SSB and the BWP (BWP #x) carrying data are transmitted using the same beam layout (i.e. they have the same beam width). In FIG. 3B a hierarchical beam layout is shown in which the initial BWP (BWP #0) carrying the SSB uses a beam having a cell-level beamwidth (an ‘umbrella’ or ‘hierarchical’ beam) and the BWP (BWP #x) carrying data uses a smaller beam. Both these options are supported by current 3GPP specifications for NR-NTN.

Regarding SSB transmission in the initial BWP (BWP #0) there are two key possibilities, and either possibility (or both possibilities as options) may be supported in a given communication system. In the first possibility, each SSB of a given cell is transmitted in a common frequency interval (i.e. using a single BWP #0). In the second possibility, each SSB of a given cell may be transmitted in any of a plurality of different frequency intervals (i.e. in a respective one of multiple initial BWPs).

The communication system 1 shown in FIG. 1 is configured to support the definition of multiple different initial BWPs (BWP #0s) to allow different frequency ranges to be used for different SSB beams that together form a single cell (although it is not limited to supporting multiple initial BWPs for different SSBs).

Thus, a single channel may include multiple SS/PBCH transmissions distributed across the channel bandwidth. This could be applied, for example, when the channel bandwidth is divided into multiple Bandwidth Parts. A UE 3 can then use an SS/PBCH transmission in a particular initial BWP for downlink measurements such as reference signal received power (RSRP) and as reference signal received quality (RSRQ). The multiple SS/PBCH transmissions can thus help reduce to the cell search time.

Beneficially, in the communication system 1, the supported sizes of the initial DL BWP are increased, from the 24, 48 or 96 RBs (corresponding to the supported CORSET sizes) currently provided for, to take account of the increased cell size of satellite cells. The supported sizes may be extended, for example, to include a 192 RB option or even more.

The communication system 1 is also able to implement a BWP switching (or ‘selection’) mechanism to allow a specific BWP to be selected as the active BWP for communication.

For example, for a serving cell, the RAN 8 may configure the UE 3 with a BWP inactivity timer (e.g. the configured by a bwp-InactivityTimer IE of the ServingCellConfig IE). Expiration of this timer may, for example, indicate that the UE 3 has no scheduled transmission and reception for a while on the currently active BWP. On expiry of the inactivity timer, the UE 3 can switch from a currently active BWP to a default BWP (e.g. to save power). The default DL BWP can be configured (e.g. using a defaultDownlinkBWP-Id IE of the ServingCellConfig IE). If not configured (or if the defaultDownlinkBWP-Id IE is set to zero), the UE 3 may switch to using the initial DL BWP as the default DL BWP.

Since satellite beam switching can be frequent and often highly predictable, a mechanism for configured BWP switching (e.g. involving a sequence of BWPs) may be preferable. However, current NR systems do not provide for such mechanisms.

Beneficially, therefore, the communication system 1 takes advantage of the predictability with which a given UE 3 may need to switch from one initial BWP to another initial BWP (e.g. in a new beam or cell served by the same satellite) in an NTN based system, to implement an efficient configured BWP switching mechanism.

Specifically, the communication system 1 employs a BWP switching mechanism in which the UE 3 can autonomously switch to the next (‘initial’ or ‘default’) BWP in a sequence of initial (or default) BWPs, rather than switching back to the same original initial BWP following a period of inactivity.

The RAN equipment 8 (e.g. gNB 5) and UE 3 are configured to support enhanced timer-based BWP switching to a new default (or ‘initial’) BWP from a set of default (or ‘initial’) BWPs configured for that UE 3, for example by means of a new information element (e.g. a defaultDLBWPIdSet IE) or the like that defines the set of default BWPs for fall back. The set of default (or initial) BWPs may be configurable by broadcast (e.g. a system information broadcast) and/or by dedicated signalling (e.g. by RRC signalling).

The UE 3 can therefore autonomously switch to the next BWP (i.e. the new initial BWP in the set of initial BWPs (BWP #0s), or next default BWP Id of the set of default BWPs) as defined by the new information element (e.g. a defaultDLBWPIdSet IE).

For this configured BWP switching in NTN, both the base station 5 and the UE 3 are configured to map the set of BWPs to a grid including the UE's location. Information for assisting this mapping may be provided by the base station 5 either via broadcast signalling (e.g. in a system information block such as SIB1) or dedicated (RRC) signalling). Thus, the UE 3 is able to select the next applicable BWP (without data scheduling) based on a Global Navigation Satellite System (GNSS) acquired location. The UE 3 can then perform the BWP switching at the expiry of the inactivity timer.

Beneficially, in the event of beam failure and associated beam failure recovery, the base station 5 is able to confirm the UE's new BWP based on information provided during a random access (RA) procedure to (re)establish a connection (e.g. the new BWP may be identified from a physical random access channel, ‘PRACH’, preamble).

Accordingly, considering the potential larger cell coverage and long roundtrip time (RTT) for NTT systems, the prediction-based mechanism for configured BWP switching from a sequence of BWPs can provide benefits compared to simply switching back to the same initial BWP (or default BWP) following a period of inactivity. Since the base station 5 can broadcast the ephemeris information to the UE 3, the configured BWP switching can beneficially be supported based on the UE's GNSS-acquired position and the serving satellite ephemeris.

This also reduces power consumption, especially for cases when measurement can be avoided.

Beneficially, in the communication system 1, the base station 5 may also instruct the UE 3 to report measurements (e.g. RSRP and/or RSRQ) for a particular SSB beam (and hence the corresponding BWP), when the UE3 is approaching a point where it will need to switch to that SSB beam and hence the next BWP (i.e. rather than more frequently such as at a defined periodicity). Only when a reporting event is triggered, such as by a measurement value (e.g. the layer 1, ‘L1’, filtered RSRP value or the like) meeting a particular reporting criterion, does the UE 3 report the measurement results to the base station 5.

Reporting may be triggered, for example, when a measurement value for the new SSB beam/BWP exceeds a particular threshold (new RSRP>threshold1) and/or when a measurement value for the new SSB beam/BWP exceeds a measurement value for the old SSB beam/BWP by a predetermined amount (new RSRP−old RSRP>delta value). It will be appreciated that any suitable reporting criteria may be defined.

The UE 3 may then send the measurement report(s) to the base station 5 so that the base station 5 will have the same measurement information as the UE 3, for UE initiated configured BWP switching. The UE 3 may then initiate BWP switching upon expiry of the BWP inactivity timer (or on expiry of another timer—e.g. a dedicated BWP switching timer that runs from when the measurement report is triggered).

It will be appreciated that the triggering of measurement reporting may, in itself, represent an additional or alternative criterion for switching to the next BWP in a set of BWPs to traverse to (i.e. following the expected satellite movement). Specifically, whilst the L1 measurement report can effectively inform the base station about potential upcoming BWP switching upon timer expiry, the transmission of the L1 measurement report may, itself, act as a triggering event (with associated notification to the base station 5) for BWP switching.

The NTN RAN 8 is also configured to use polarization to help to mitigate inter-beam and inter-cell interference. For polarization multiplexing, the satellite may transmit different streams with different polarizations in the same satellite beam although this may not be supported by all satellites. For polarization used for inter-beam interference mitigation, the polarization for each beam in one cell does not need to change dynamically. Moreover, a dynamic change of polarization information may also impact the beam layout. Beneficially, therefore, the communication system 1 does not implement dynamic change of polarization for each beam of a cell (although it will be appreciated that the communication system could implement such a dynamic change if needed).

The lack of dynamic change of polarization for each beam means that it is not necessary to indicate, to the UE 3, the polarization used in a particular beam dynamically. This allows for a particularly efficient signalling mechanism to be used for providing an indication of the polarization used (e.g. right-hand circular polarization, ‘RHCP’, left-hand circular polarization, ‘LHCP’, and/or linear polarization).

Beneficially, therefore, the RAN 8 (e.g. base station 5) provides an explicit indication of polarization information, for at least the DL (and optionally the UL as well), in a system information block (for example SIB1).

Specifically, in the communication system 1, the RAN equipment 8 (e.g. base station 5) provides a polarization indication (e.g. Linear, RHCP, LHCP). This polarization indication may be on a per satellite beam basis for each cell, and is grouped for the DL and, where applicable, UL respectively. The polarization indication may be provided in any suitable form, for example as a two-bit binary representation (e.g. respectively 00, 01, 10, or the like) or any other suitable indication. The polarization indication is beneficially provided with a periodicity corresponding to the periodicity at which the satellite's ephemeris information is updated by the RAN 8 due to movement of the satellite relative to the surface of the Earth. If UL polarization information is absent, then the UE 3 may assume that polarization for the UL and DL is the same.

For downlink, UEs 3 with a linear polarization antenna can receive circular polarization signal and UE with circular polarization antenna can receive linear polarization signal.

For the UL, however, it is possible that different UEs 3 have different polarization transmission capabilities. For example, one or more UEs 3 that do not support circular polarization transmission and one or more UEs 3 that only support circular polarization transmission may both exist in a particular scenario. It is beneficial, therefore, for the polarization capability of the UEs 3 to be known to the RAN 8 (e.g. base station 5) for UL scheduling purposes. To support this, the UE 3 is beneficially configured for providing a polarization capability indication to the base station 5 (e.g. indicating the capability to be Linear, RHCP, LHCP, or both RHCP and LHCP). This polarization capability indication is provided in a UE Capability Indication and may be in any suitable form, for example as a two-bit binary representation (e.g. 00,01,10,11 respectively representing Linear, RHCP, LHCP, and both RHCP and LHCP, or the like).

It can be seen, therefore, that the communication system provides a number of advantages and, in particular, reduced overhead and processing time. The proposed system supports a near seamless BWP switching scheme for UEs under the same satellite with large propagation delay.

Specifically, in NTN, the beams from the same satellite may provide similar services, and the desired BWP configurations are similar. For example, the BWPs may be identical except for the frequency location. Moreover, different beams of a satellite may have different carrier frequencies but require the same transmit and receive spatial direction at a UE 3. For conventional BWPs, when the network re-configures a new BWP, it provides an associated new configuration, e.g. pdcch-Config, pdsch-Config, sps-Config, radioLinkMonitorConfig etc. For NTN beams of the same satellite, however, only the frequency location as identified by BWP ID may be changed and, accordingly, most of the configurations can remain the same. The communication system takes advantage of this to provide a particularly efficient BWP switching scheme.

The way in which the information on polarization is explicitly notified to the UE represents a particularly efficient way of avoiding both the additional UE complexity and processing delay that might otherwise arise for SSB detection, and the potential for detecting the wrong polarization.

Various apparatus that may be used for implementing the system 1 will now be described, by way of example only.

### NTN RAN

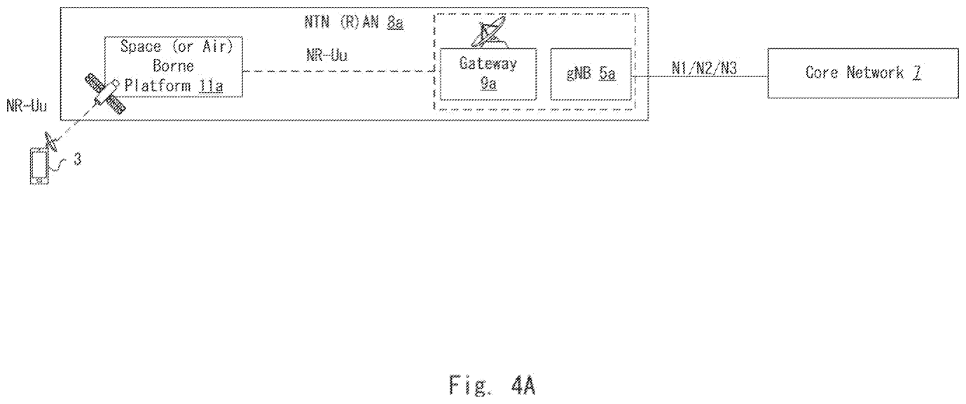

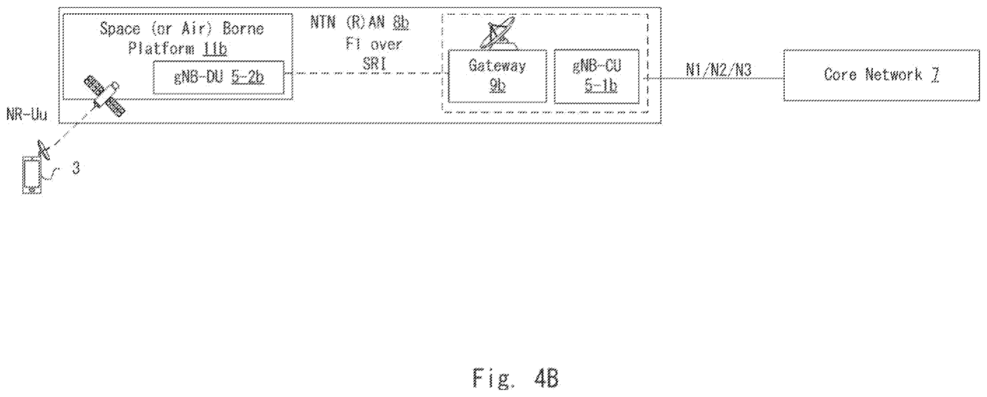

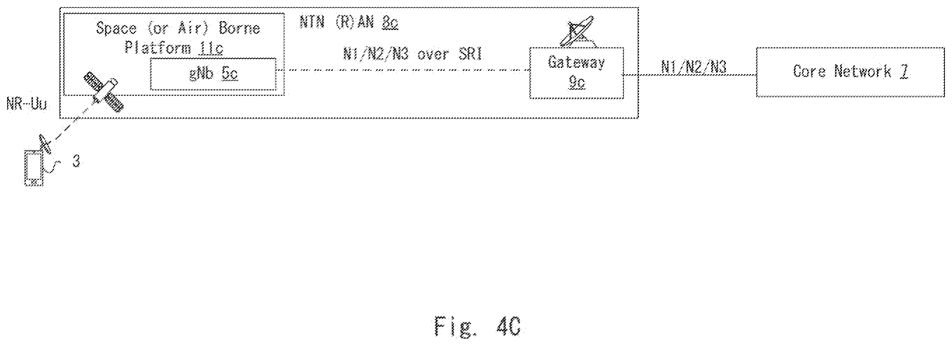

FIGS. 4A to 4C each respectively illustrate a possible implementation of an access network 8 that may be used in the system of FIG. 1. As seen in FIGS. 4A to 4C the NTN RAN 8 may be implemented in a number of different ways.

For example, as seen in FIG. 4A, the base station 5 may comprise a terrestrially located base station 5a that sends and receives communications respectively destined for and originating from the UEs 3 via a terrestrially located gateway 9a and via a non-terrestrial platform 11a that has no base station functionality. The non-terrestrial platform 11a relays these communications to and from the UEs 3 in the cell(s) operated by the base station 5a, and from and to the gateway 9a as required. The non-terrestrial platform 11a relays these communications transparently without on-board processing them in effect acting as a so-called ‘bent-pipe’. In this implementation, the feeder link between the gateway 9a and the non-terrestrial platform 11a effectively acts as part of the NR-Uu interface (or reference point) between the base station 5a and the UE(s) 3. Similarly, the service link between the non-terrestrial platform 11a and the UE(s) 3 effectively acts as another part of the NR-Uu interface (or reference point) between the base station 5a and the UE(s) 3. The base station's communication link with the core network 7 (e.g. for signalling over the N1, N2, N3 interface/reference point etc.) is provided solely terrestrially.

As seen in FIG. 4B the base station 5 may, for example, comprise a base station 5b of a distributed type having a terrestrially located central unit (CU) 5-1b and a distributed unit (DU) 5-2b provided on-board the non-terrestrial platform 11b. The terrestrially located CU 5-1b performs some of the (typically higher layer) functionality of the base station 5b whereas the non-terrestrially located DU 5-2b performs other (typically lower layer) functionality of the base station 5b. The terrestrially located CU 5-1b communicates with the non-terrestrially located DU 5-2b via the gateway 9b and an F1 interface implemented via a satellite radio interface between the gateway 9b and the non-terrestrial platform 11b in which the DU 5-2b is provided.

The non-terrestrial platform 11b transmits communications destined for and originating from the UEs (3) in the cell(s) operated by the base station 5b, and from and to the gateway 9a as required. However, in this implementation lower layer processing of communication respectively destined for and originating from the UEs (3) is performed on-board the non-terrestrial platform 11b by the DU 5-2b and higher layer processing of that communication respectively destined for and originating from the UEs (3) is performed by the terrestrially located CU 5-1b.

Accordingly, in this implementation, the feeder link between the gateway 9b and the non-terrestrial platform 11b effectively acts as the F1 interface (or reference point) between the CU and DU of the base station 5b. The service link between the non-terrestrial platform 11b and the UE(s) 3, on the other hand, effectively acts as the NR-Uu interface (or reference point) between the base station 5b and the UE(s) 3. The base station's communication link with the core network 7 (e.g. for signalling over the N1, N2, N3 interface/reference point etc.) is provided solely terrestrially.

As seen in FIG. 4C the base station 5 may, for example, comprise a base station 5c provided on-board the non-terrestrial platform 11c. The base station 5c on board the non-terrestrial platform 11c transmits communications destined for and originating from the UEs (3) in the cell(s) operated by the base station 5c, and from and to the core network 7 via the gateway 9c as required. However, in this implementation, processing of communication respectively destined for and originating from the UEs (3) is performed on-board the non-terrestrial platform 11c by the base station 5c.

Accordingly, in this implementation, the feeder link between the gateway 9c and the non-terrestrial platform 11b effectively acts as part of the N1/N2/N3 interfaces (or reference points) between the base station 5c and the core network 7. The base station's communication link with the core network 7 (e.g. for signalling over the N1, N2, N3 interface/reference point etc.) is thus provided partly via the feeder link and partly terrestrially. The service link between the non-terrestrial platform 11c and the UE(s) 3, on the other hand, effectively acts as the NR-Uu interface (or reference point) between the base station 5c and the UE(s) 3.

The base station 5 thus controls one or more associated cell(s) via the non-terrestrial platform 11. It will be appreciated that the base station 5 may be configured to support both 4G and 5G, and/or any other 3GPP or non-3GPP communication protocols.

### User Equipment

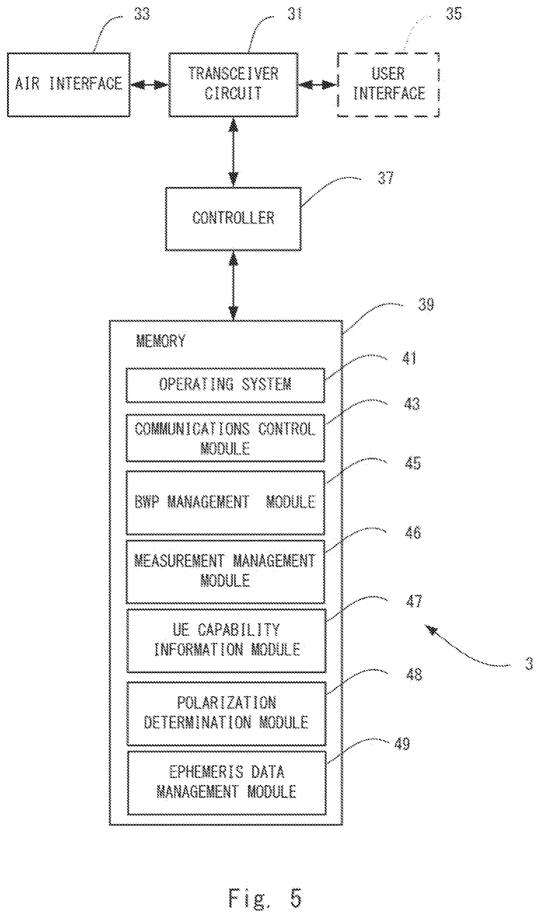

FIG. 5 is a simplified block schematic illustrating the main components of a UE 3 for implementation in the system of FIG. 1.

As shown, the UE 3 comprises transceiver circuitry 31 that is operable to transmit signals to and to receive signals from a base station 5 via an air interface 33 and one or more antennas (e.g. indirectly via a non-terrestrial platform 11 and possibly gateway 9 where applicable or directly in a wholly terrestrial scenario).

The UE 3 has a controller 37 to control the operation of the UE 3. The controller 37 is associated with a memory 39 and is coupled to the transceiver circuit 31. Although not necessarily required for its operation, the UE 3 might, of course, have all the usual functionality of a conventional UE 3 (e.g. a user interface 35, such as a touch screen/keypad/microphone/speaker and/or the like for, allowing direct control by and interaction with a user) and this may be provided by any one or any combination of hardware, software and firmware, as appropriate.

The controller 37 is configured to control overall operation of the UE 3 by, in this example, program instructions or software instructions stored within the memory 39. The software may be pre-installed in the memory 39 and/or may be downloaded via the telecommunications network or from a removable data storage device (RMD), for example. As shown, these software instructions include, among other things, an operating system 41, a communications control module 43, a BWP management module 45, a measurement management module 46, a UE capability information module 47, and polarization determination module 48, and an ephemeris data management module 49.

The communications control module 43 is operable to control the communication between the UE 3 and the base station 5. For example, the communications control module 43 controls the part played by the UE 3 in the flow of uplink and downlink user traffic and of control data to be transmitted from the base station 5 including, for example, control data for managing operation of the UE 3. The communication control module 43 is responsible, for example, for controlling the part played by the UE 3 in procedures such as the reception of measurement control/configuration information, reception of system information, RRC signalling, mobility procedures, implementing appropriate timing advances to compensate for timing misalignments etc.

The BWP management module 45 manages the performance of BWP related procedures such: as BWP configuration at the UE 3; BWP switching (including autonomous timer based or measurement triggered BWP switching); keeping track of the BWP inactivity timer; maintaining the set of initial/default BWPs configured by the base station; mapping the set of BWPs to the current UE GNSS location as the UE 3 effectively traverses the SSB beams provided by the NTN RAN 8 as a result of satellite to Earth relative movement; associated identification of the next BWP in the set of BWPs (e.g. based on the mapping and ephemeris data for the satellite provided by the base station 5) etc.

The measurement management module 46 manages the performance of measurement related procedures such as: configuration of measurements performed by the UE 3 and/or related reporting event triggers in accordance with a measurement configuration provided by the base station 5; performance of configured L1 filtered and other measurements (e.g. RSRP, RSRQ etc.); detection of measurement reporting triggering events; the sending of measurement reports; etc.

The UE capability information module 47 maintains the UE capability information comprising indications of UE capability such as, for example, the UE polarization capability and the like and provides the UE capability information to the base station 5 when appropriate (e.g. in response to a UE capability enquiry and/or automatically in response to some other event at the UE).

The polarization determination module 48 determines the DL and, where applicable, UL polarization applied at the NTN RAN 8 (e.g. from the polarization indication received from the base station 5).

The ephemeris data management module 49 is responsible for performing ephemeris data related procedures at the UE 3 such as: receiving and interpreting ephemeris data at the UE 3; updating the ephemeris data periodically in accordance with updates from the base station 5 as the satellite 11 moves relative to the Earth; etc.

### Base Station (Non-Distributed Type)

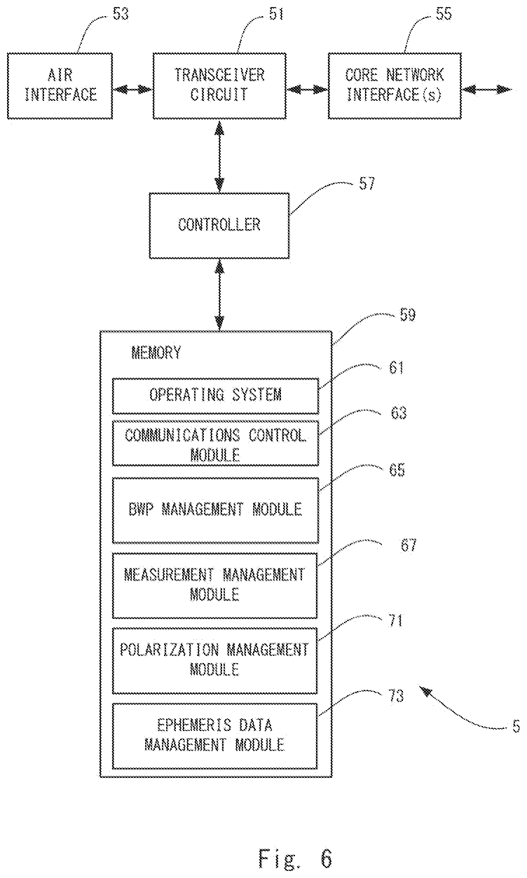

FIG. 6 is a simplified block schematic illustrating the main components of a base station 5 comprising a non-distributed type base station for implementation in the system of FIG. 1 (e.g. in an NTN access network 8 such as RAN 8a in FIG. 4A or RAN 8c in FIG. 4C or in a wholly terrestrial RAN).

As shown, the base station 5 comprises transceiver circuitry 51 that is operable to transmit signals to and to receive signals from UEs 3 via an air interface 53 and one or more antennas (e.g. of the gateway 9 or non-terrestrial platform 11). The transceiver circuitry 51 is also operable to transmit signals to and to receive signals from functions of the core network 7 and/or other base stations 5 via a network interface 55. The network interface typically includes an N1, N2 and/or N3 interfaces for communicating with the core network and a base station to base station (e.g. Xn) interface for communicating with other base stations.

The base station 5 also comprises a controller 57 which controls the operation of the transceiver circuitry 51 in accordance with software stored in memory 59. The software may be pre-installed in the memory 59 and/or may be downloaded via the communications network 1 or from a removable data storage device (RMD), for example. The software includes, among other things, an operating system 61, a communications control module 63, a BWP management module 65, a measurement management module 67, a polarization management module 71, and an ephemeris data management module 73.

The communications control module 63 is operable to control the communication between the base station 5 and the UEs 3 and between the base station 5 and other network entities that are connected to the base station 5. For example, the communications control module 63 controls the part played by the base station 5 in the flow of uplink and downlink user traffic and of control data to be transmitted to the UE(s) 3 served by the base station 5 including, for example, control data for managing operation of the UEs 3. The communication control module 63 is responsible, for example, for controlling the part played by the base station in procedures such as the communication of measurement control/configuration information, the broadcast of system information, RRC signalling, mobility procedures, determining and signalling appropriate timing advances to compensate for timing misalignments etc.

The BWP management module 65 manages the performance of BWP related procedures such: providing information to the UE 3 (e.g. via system information or dedicated signalling) for BWP configuration at the UE 3; keeping track of the BWP inactivity timer at the base station; configuring and maintaining the set of initial/default BWPs configured for the UEs served by the NTN RAN 8 of which the base station 5 is a part; mapping the set of BWPs to the current UE locations as the UEs 3 effectively traverse the SSB beams provided by the NTN RAN 8 as a result of satellite to Earth relative movement; associated identification of the next BWP in the set of BWPs for each UE 3 (e.g. based on the mapping and ephemeris data for the satellite) etc.

The measurement management module 67 manages the performance of measurement related procedures such as: provision of measurement configuration information to the UE 3 for the configuration of measurements performed by the UE 3 and/or related reporting event triggers; the receipt and interpretation of measurement reports; interpretation of L1 filtered and other measurement results (e.g. RSRP, RSRQ etc.) provided by the UE 3 in measurement reports; etc.

The polarization determination management module 71 performs polarization related procedures at the base station 5 including, for example: configuring polarization at the base station (possibly taking account of a UE polarization capability if available); provision the polarization indication to the UE 3; etc.

The ephemeris data management module 73 is responsible for performing ephemeris data related procedures at the base station 5 such as: maintaining up-to-data ephemeris data at the base station 5; providing the ephemeris data to the UE 3; updating the ephemeris data periodically as the satellite 11 moves relative to the Earth; etc.

### Base Station (Distributed Type)

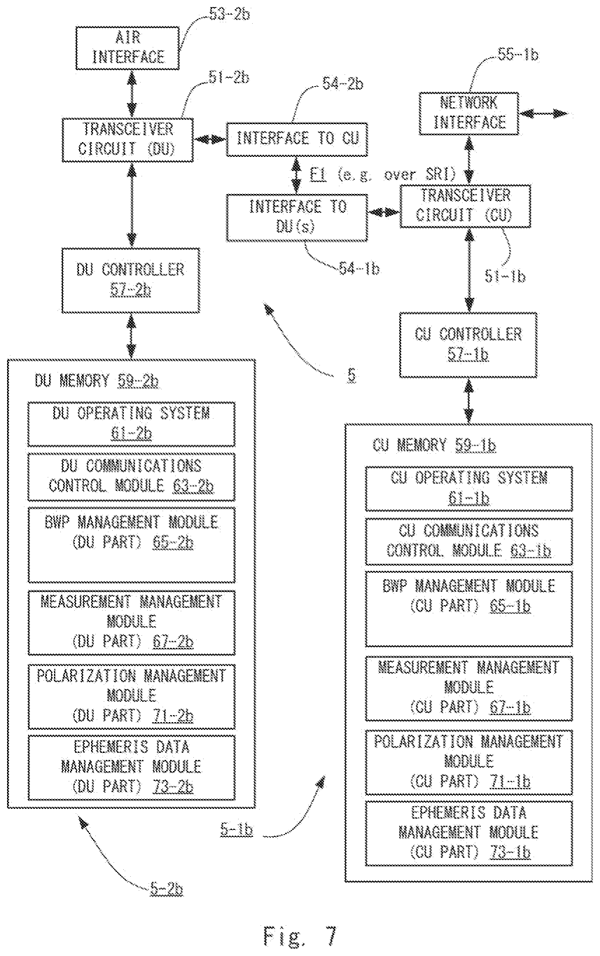

FIG. 7 is a simplified block schematic illustrating the main components of a base station 5 comprising a distributed type base station for implementation in the system of FIG. 1 (e.g. in an NTN access network 8 such as RAN 8b in FIG. 4B or in a wholly terrestrial RAN).

As shown, the base station 5 includes a distributed unit 5-1b and a central unit 5-2b. Each unit 5-1b, 5-2b includes respective transceiver circuitry 51-1b, 51-2b. The distributed unit 5-2b transceiver circuitry 51-2b is operable to transmit signals to and to receive signals from UEs 3 via an air interface 53-2b and one or more antennas (e.g. of the non-terrestrial platform 11 where the distributed unit of the base station 5-2b is onboard such a platform 11) and is also operable to transmit signals to and to receive signals from the central unit 5-1b via an interface 54-2b, for example the distributed unit side of an F1 interface (which may be provided over a satellite radio interface).

The central unit 5-1b transceiver circuitry 51-1b is operable to transmit signals to and to receive signals from functions of the core network 7 and/or other base stations 5 via a network interface 55-1b. The network interface typically includes an N1, N2 and/or N3 interfaces for communicating with the core network and a base station to base station (e.g. Xn) interface for communicating with other base stations. The central unit 5-1b transceiver circuitry 51-1b is also operable to transmit signals to and to receive signals from one or more distributed units 5-2b, for example the central unit side of an F1 interface provided, via the gateway 9b, over a satellite (or airborne platform) radio interface.

Each unit 5-1b, 5-2b includes a respective controller 57-1b, 57-2b which controls the operation of the corresponding transceiver circuitry 51-1b, 51-2b in accordance with software stored in the respective memories 59-1b and 59-2b of the distributed unit 5-2b and the central unit 5-1b. The software of each unit may be pre-installed in the memory 59-1b, 59-2b and/or may be downloaded via the communications network 1 or from a removable data storage device (RMD), for example. The software of each unit includes, among other things, a respective operating system 61-1b, 61-2b, a respective communications control module 63-1b, 63-2b, a respective BWP management module 65-1b, 65-2b, a respective measurement management module 67-1b, 67-2b, a respective polarization management module 71-1b, 71-2b, and a respective ephemeris data management module 73-1b, 73-2b.

Each communications control module 63-1b, 63-2b is operable to control the communication of its corresponding unit 5-1b, 5-2b including the communication from one unit to the other. The communications control module 63-2b of the distributed unit 5-2b controls communication between the distributed unit 5-2b and the UEs 3, and the communications control module 63-1b of the central unit 5-1b controls communication between the central unit 5-1b and other network entities that are connected to the distributed type base station 5b.

The communications control modules 63-1b, 63-2b also respectively control the part played by the distributed unit 5-2b and central unit 5-1b in the flow of uplink and downlink user traffic and control data to be transmitted to the communications devices served by the base station 5b including, for example, control data for managing operation of the UEs 3. Each communication control module 63-1b, 63-2b is responsible, for example, for controlling the respective part played by the distributed unit 5-2a and central unit 5-2b in procedures such as the communication of measurement control/configuration information, the broadcast of system information, RRC signalling, mobility procedures, determining and signalling appropriate timing advances to compensate for timing misalignments etc.

The BWP management modules 65-1b, 65-2b respectively manage the part played by the distributed unit 5-2b and central unit 5-1b in the performance of BWP related procedures such: providing information to the UE 3 (e.g. via system information or dedicated signalling) for BWP configuration at the UE 3; keeping track of the BWP inactivity timer at the base station; configuring and maintaining the set of initial/default BWPs configured for the UEs served by the NTN RAN 8 of which the base station 5 is a part; mapping the set of BWPs to the current UE locations as the UEs 3 effectively traverse the SSB beams provided by the NTN RAN 8 as a result of satellite to Earth relative movement; associated identification of the next BWP in the set of BWPs for each UE 3 (e.g. based on the mapping and ephemeris data for the satellite) etc.

The measurement management modules 67-1b, 67-2b respectively manage the part played by the distributed unit 5-2b and central unit 5-1b in the performance of measurement related procedures such as: provision of measurement configuration information to the UE 3 for the configuration of measurements performed by the UE 3 and/or related reporting event triggers; the receipt and interpretation of measurement reports; interpretation of L1 filtered and other measurement results (e.g. RSRP, RSRQ etc.) provided by the UE 3 in measurement reports; etc.

The polarization determination management modules 71-1b, 71-2b respectively perform the part played by the distributed unit 5-2b and central unit 5-1b in the performance of polarization related procedures at the base station 5 including, for example: configuring polarization at the base station (possibly taking account of a UE polarization capability if available); provision the polarization indication to the UE 3; etc.

The ephemeris data management modules 73-1b, 73-2b are respectively responsible for the part played by the distributed unit 5-2b and central unit 5-1b in performing ephemeris data related procedures at the base station 5 such as: maintaining up-to-data ephemeris data at the base station 5; providing the ephemeris data to the UE 3; updating the ephemeris data periodically as the satellite 11 moves relative to the Earth; etc.

Various methods that may be used in the system 1 will now be described, by way of example only.

### Configured BWP Switching

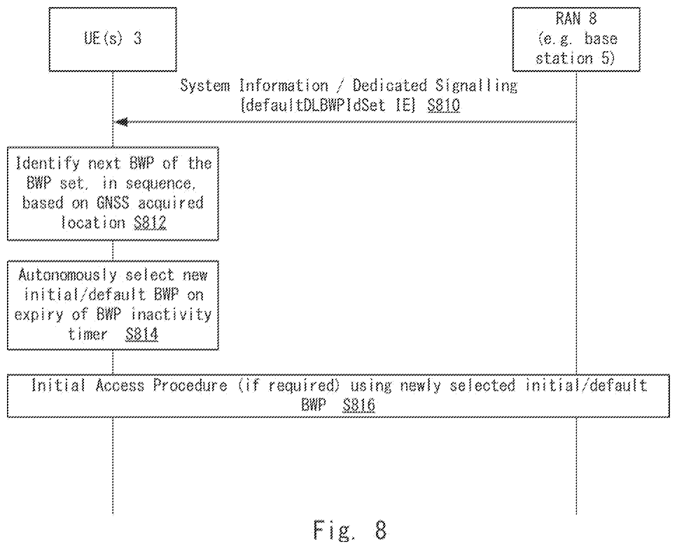

FIG. 8 is a simplified flow diagram illustrating a configured BWP switching procedure that may be used in the system of FIG. 1.

As seen in FIG. 8, the base station provides information identifying a set of default (or ‘initial’) BWPs to the UE 3 at S810 (e.g. in a defaultDLBWPIdSet or similar IE). This information may be provided in a system information block (e.g. SIB1) and/or using dedicated signalling when the UE 3 has an RRC connection with the base station 5. This set of default BWPs is mappable by both the UE 3, and the base station 5, to a terrestrial grid that includes the current location of the UE 3. Moreover, both the UE 3 and base station 5 can track the change in the mapping of the default BWPs to the terrestrial grid, as the satellite 11 moves relative to the Earth (e.g. based on ephemeris data). This allows the UE 3 (and the base station 5) to identify which BWP is next in sequence, for example based on a predicted change of the position of the UE 3 relative to the coverage area of the NTN RAN 8.

Accordingly, the UE 3 is able to identify the next BWP, of the configured set of BWPs, in sequence that the UE 3 should switch to at S812 (e.g. based on the UE's GNSS location and the mapping of the BWPs to the terrestrial grid).

The UE 3 autonomously selects the next BWP to be its new BWP and switches to it, on expiry of the BWP inactivity timer, at S814.

Should the UE 3 require a connection, the UE 3 can then, at S816, perform an initial access procedure with the base station 5 using the new BWP. Alternatively, the UE 3 may repeat steps S812 and S814 until an initial access is required.

### Measurement Based BWP Switching

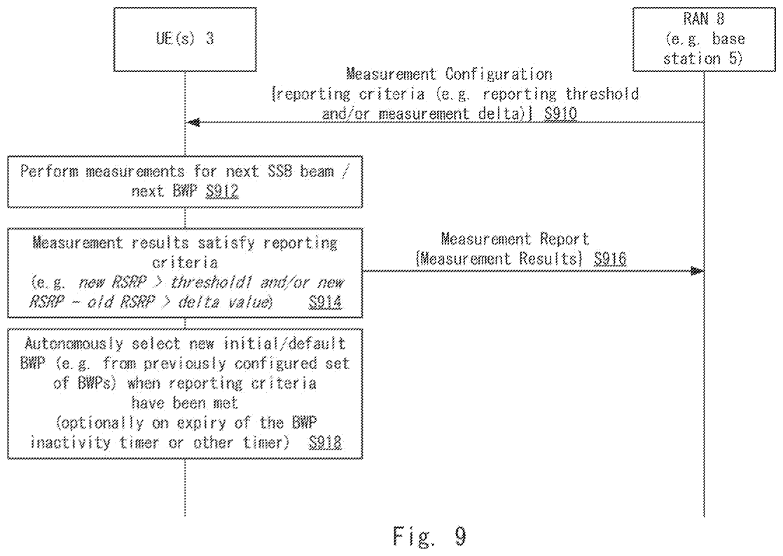

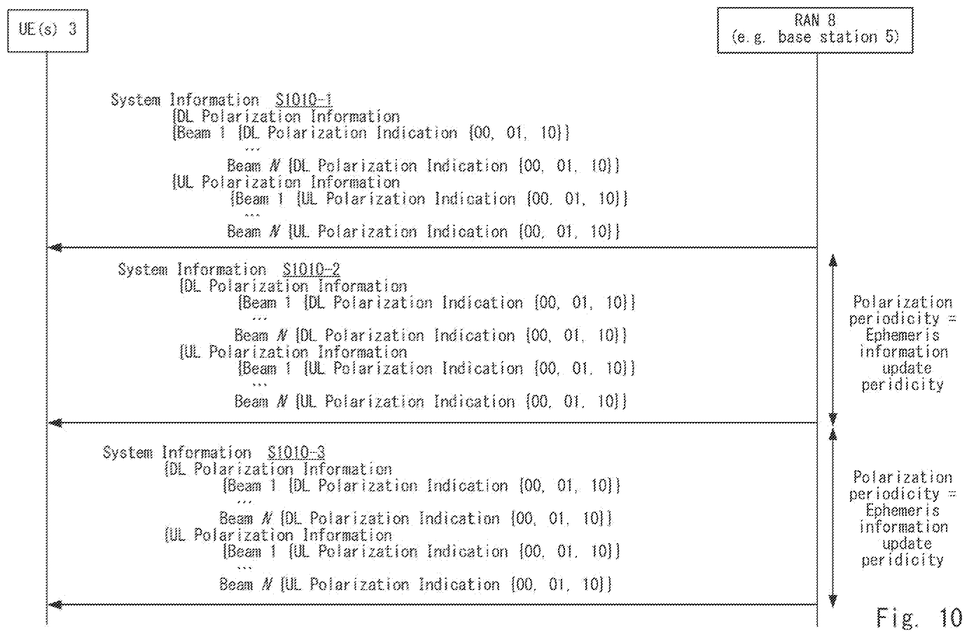

FIG. 9 is a simplified flow diagram illustrating a measurement-based BWP switching procedure that may be used in the system of FIG. 1.

In FIG. 9, it is assumed that the UE 3 is configured with a set of default (or ‘initial’) BWPs (e.g. based on system information or dedicated signalling as shown at S810 in FIG. 8 or in some other way).

The base station 5 provides, at S910, measurement configuration information for configuring the UE 3 to perform measurements for the purposes of BWP switching. This measurement configuration information includes information for configuring reporting criteria such as one or more reporting thresholds (e.g. threshold1) and/or for configuring a measurement delta between measurements for a previous BWP and the next BWP in sequence.

The UE 3 performs measurements for the next BWP (i.e. in the next SSB beam) at S912 based on the measurement configuration. When the measurement results satisfy the reporting criteria, at S914, then a measurement report is sent to the base station 5 at S916. The measurement report may be sent, for example, when a measurement value (e.g., RSRP) for the next BWP exceeds a configured threshold (new RSRP>threshold1) and/or exceeds a corresponding measurement value for the current BWP by a configured amount (new RSRP−old RSRP>delta value).

The UE 3 may then autonomously switch to the next BWP in sequence at S918. This switching may be triggered by the BWP inactivity timer, another timer (e.g. that is started when the measurement reporting criteria are met) or may be triggered simply by the measurement reporting criteria being met/by the measurement report being sent.

### NTN Polarization Information

FIG. 10 is a simplified flow diagram illustrating a procedure for providing a UE with polarization information that may be used in the system of FIG. 1.

As seen in FIG. 10, the base station 5 provides system information comprising the polarization information for the NTN RAN 8 at S1010-1. The polarization indication in FIG. 10 is grouped by DL and UL and, in the example shown, is provided per beam. It will be appreciated, however, that the polarization information may only be provided for the DL (and the UE 3 may assume that it is the same for the UL). It will also be appreciated that the polarization information need not be provided on a per beam basis.

The polarization indication in this example comprises a two-bit binary representation (e.g. 00, 01 and 10, to respectively represent Linear, RHCP and LHCP) although any suitable indication may be used.

Updates to the polarization information are provided regularly (e.g. as indicated at S1010-2 and S1010-3) with a periodicity corresponding to the period of the ephemeris information updates due to satellite movement relative to the Earth.

### UE Polarization Information

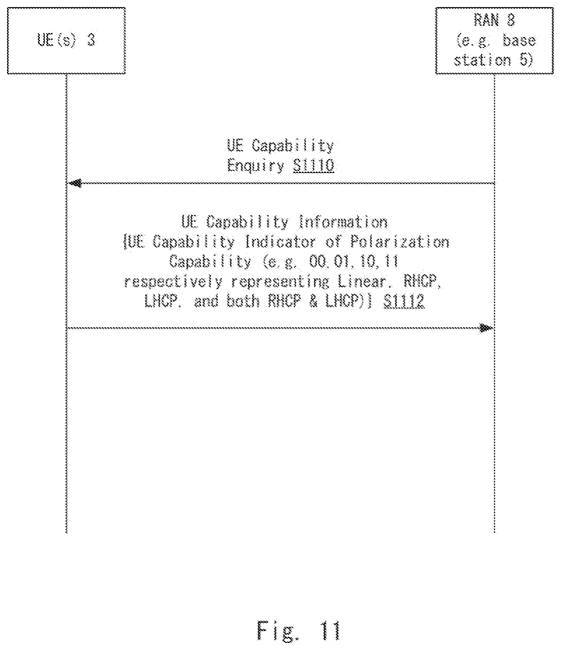

FIG. 11 is a simplified flow diagram illustrating a procedure for providing a base station with an indication of a UE's polarization capability that may be used in the system of FIG. 1.

As seen in FIG. 11, the UE 3 provides, at S1112, UE Capability information in response to a UE capability enquiry from the base station 5 at S1110. The UE Capability information comprises a UE capability indicator for indicating the polarization capability of the UE. The UE capability information and UE capability enquiry may be provided using any suitable signalling, for example RRC signalling.

The UE polarization capability indication in this example comprises a two-bit binary representation (e.g. 00, 01, 10 or 11, to respectively represent Linear, RHCP, LHCP, or both RHCP and LHCP polarization capability) although any suitable indication may be used.

Modifications and Alternatives A detailed embodiment has been described above. As those skilled in the art will appreciate, a number of modifications and alternatives can be made to the above embodiments whilst still benefiting from the disclosures embodied therein.

It will be appreciated that description of features of and actions performed by a base station (or gNB) apply equally to distributed type base stations as to non-distributed type base stations.

In the above description, the polarization indication is signalled using information elements of a system information block (e.g. SIB1). It will be appreciated, however, that the polarization indication could be signalled using other signalling (e.g. a dedicated RRC message, or a modified RRC message for some other purpose) using similar (or the same) information elements described for the system information block.

It will also be appreciated whilst IEs having specific names have been described, differently named IEs but having a similar purpose may be used.

As those skilled in the art will understand, whilst the information for identifying the set of BWPs may be suitable for identifying a plurality of BWPs, it is possible that in a particular scenario the identified set of BWPs may comprise only a single BWP (e.g a BWP determined to be the next in sequence for the UE).

It will be appreciated that whilst the polarization indication is described as being provided at a periodicity corresponding to the periodicity of the ephemeris data the periodicity with which the polarization indication is provided may be linked-to but not identical to the periodicity of the ephemeris data. For example, the periodicities may be linked to one another by an integer multiplier/divisor or in some other way.

In the above description, the UEs and the base station are described for ease of understanding as having a number of discrete functional components or modules. Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities.

In the above embodiments, a number of software modules were described. As those skilled in the art will appreciate, the software modules may be provided in compiled or un-compiled form and may be supplied to the base station or to the UE as a signal over a computer network, or on a recording medium. Further, the functionality performed by part or all of this software may be performed using one or more dedicated hardware circuits. However, the use of software modules is preferred as it facilitates the updating of the base station or the UE in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; moulds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyser, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that ToT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine type communication applications.

| Service Area | MTC applications |
|---|---|
| Security | Surveillance systems |
| | Backup for landline |
| | Control of physical access |
| | (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Further, the above-described UE categories are merely examples of applications of the technical ideas and exemplary embodiments described in the present document. Needless to say, these technical ideas and embodiments are not limited to the above-described UE and various modifications can be made thereto.

It can be seen, in summary, that in one example described herein there is disclosed a method performed by a user equipment (UE) in a communication system, the method comprising: receiving, from a node of an access network, information for identifying an initial bandwidth part for communication between the UE and the access network in a first part of a communication coverage area provided by the access network, and information for identifying a set of one or more bandwidth parts, each bandwidth part of the set of bandwidth parts respectively being for potential future communication between the UE and the access network in a corresponding further part of the communication coverage area; identifying a next bandwidth part of the set of bandwidth parts, for switching to from the initial bandwidth part as a position of the UE relative to the communication coverage area enters, or is approaching, the further part of the communication coverage area corresponding to the identified next bandwidth part; and switching to the identified next bandwidth part.

The switching to the identified next bandwidth part may occur when a timer expires. The timer may be a bandwidth part inactivity timer. The identifying of a next bandwidth part of the set of bandwidth parts may be determined based on a mapping between the set of bandwidth parts and a current location of the UE. Switching to the identified next bandwidth part may be initiated by the UE autonomously.

The method may comprise receiving information for configuring a measurement procedure to be performed by the UE for at least one beam in respect of which the identified next bandwidth part is to be used, and performing a measurement procedure based on the information for configuring the measurement procedure. The information for configuring the measurement procedure may comprise information for configuring at least one criterion for triggering transmission of a measurement report. The information for configuring at least one criterion for triggering transmission of the measurement report may comprise information defining a threshold, wherein transmission of the measurement report is triggered when a measurement value exceeds, or is no less than, the threshold. The information for configuring at least one criterion for triggering transmission of the measurement report may comprise information defining a measurement value delta, wherein transmission of the measurement report is triggered when a difference between a measurement value for the at least one beam in respect of which the identified next bandwidth part is to be used, and a measurement value for a beam in respect of which the initial bandwidth part is used, exceeds, or is no less than, the measurement value delta.

Switching to the identified next bandwidth part may be triggered autonomously by the UE, when the at least one criterion for triggering transmission of a measurement report is satisfied. The measurement report may serve as a notification to the node of the access network that bandwidth part switching has been triggered. The UE relative to the communication coverage area may change as a result of movement of coverage area relative to an Earth surface. The access network may be non-terrestrial network (NTN) access network.

In one example described herein there is disclosed a method performed by a user equipment (UE) in a communication system, the method comprising: receiving, from a node of a non-terrestrial network (NTN) access network, information identifying at least one polarization employed by the NTN access network for communication in at least part of a communication coverage area provided by the NTN access network; communicating with the NTN access network based on the information identifying at least one polarization employed by the access network; and receiving, from the node of the NTN access network, ephemeris information for a satellite of the NTN access network, wherein updates to the ephemeris information are received at a first periodicity; wherein updates to the information identifying at least one polarization employed by the access network are received at a second periodicity corresponding to the first periodicity at which the updates to the ephemeris information are received.

The information identifying at least one polarization employed by the NTN access network may comprise at least one polarization indication for downlink (DL) communication. The information identifying at least one polarization employed by the NTN access network may comprise at least one polarization indication for uplink (UL) communication. The information identifying at least one polarization employed by the NTN access network may comprise at least one polarization indication for downlink (DL) communication, and at least one polarization indication for uplink (UL) communication. The at least one polarization indication for DL communication and the at least one polarization indication for UL communication may be grouped by DL and UL respectively. The NTN access network may provide a communication coverage area using at least one beam. The information identifying at least one polarization employed by the NTN access network may comprise a respective polarization indication for each beam. The information identifying at least one polarization employed by the NTN access network may indicate the at least one polarization employed by the NTN access network using a two-bit binary indication. The information identifying at least one polarization employed by the NTN access network may indicate the at least one polarization to be one of linear polarization, right-hand circular polarization, and left-hand circular polarization.

In one example described herein there is disclosed a method performed by a user equipment (UE) in a communication system, the method comprising: providing, to a node of a non-terrestrial network (NTN) access network, UE capability information comprising a capability indication for indicating a polarization capability of the UE, the capability indication for indicating a polarization capability being configurable for indicating the polarization capability to be any one of: a linear polarization capability; a right-hand circular polarization capability; a left-hand circular polarization capability; and both a right-hand circular polarization capability and a left-hand circular polarization capability.

In one example described herein there is disclosed a method performed by a node of an access network in a communication system, the method comprising: providing, to a user equipment (UE), information for identifying an initial bandwidth part for communication between the UE and the access network in a first part of a communication coverage area provided by the access network, and information for identifying a set of one or more bandwidth parts, each bandwidth part of the set of bandwidth parts respectively being for potential future communication between the UE and the access network in a corresponding further part of the communication coverage area. The node of an access network may identify a next bandwidth part of the set of bandwidth parts, for the UE to switch to from the initial bandwidth part as a position of the UE relative to the communication coverage area enters, or is approaching, the further part of the communication coverage area corresponding to the identified next bandwidth part. The node of an access network may identify when the UE has switched to the identified next bandwidth part.

In one example described herein there is disclosed a method performed by a node of a non-terrestrial network (NTN) access network in a communication system, the method comprising: providing, to a user equipment (UE), information identifying at least one polarization employed by the NTN access network for communication in at least part of a communication coverage area provided by the NTN access network; communicating with the UE based on the at least one polarization employed by the access network; and providing, to the UE, ephemeris information for a satellite of the NTN access network, wherein updates to the ephemeris information are provided at a first periodicity; wherein updates to the information identifying at least one polarization employed by the access network are provided at a second periodicity corresponding to the first periodicity at which the updates to the ephemeris information are provided.

In one example described herein there is disclosed a method performed by a node of a non-terrestrial network (NTN) access network in a communication system, the method comprising: receiving, from a UE, UE capability information comprising a capability indication for indicating a polarization capability of the UE, the capability indication for indicating a polarization capability being configurable for indicating the polarization capability to be any one of: a linear polarization capability; a right-hand circular polarization capability; a left-hand circular polarization capability; and both a right-hand circular polarization capability and a left-hand circular polarization capability.

In one example described herein there is disclosed a user equipment (UE) for a communication system, the UE comprising: a controller and a transceiver, wherein the controller is configured to: control the transceiver to receive, from a node of an access network, information for identifying an initial bandwidth part for communication between the UE and the access network in a first part of a communication coverage area provided by the access network, and information for identifying a set of one or more bandwidth parts, each bandwidth part of the set of bandwidth parts respectively being for potential future communication between the UE and the access network in a corresponding further part of the communication coverage area; identify a next bandwidth part of the set of bandwidth parts, for switching to from the initial bandwidth part as a position of the UE relative to the communication coverage area enters, or is approaching, the further part of the communication coverage area corresponding to the identified next bandwidth part; and control the transceiver to switch to the identified next bandwidth part.

In one example described herein there is disclosed a user equipment (UE) for a communication system, the UE comprising: a controller and a transceiver, wherein the controller is configured to: control the transceiver to receive, from a node of a non-terrestrial network (NTN) access network, information identifying at least one polarization employed by the NTN access network for communication in at least part of a communication coverage area provided by the NTN access network; control the transceiver to communicate with the NTN access network based on the information identifying at least one polarization employed by the access network; and control the transceiver to receive, from the node of the NTN access network, ephemeris information for a satellite of the NTN access network, wherein updates to the ephemeris information are received at a first periodicity; wherein updates to the information identifying at least one polarization employed by the access network are received at a second periodicity corresponding to the first periodicity at which the updates to the ephemeris information are received.

In one example described herein there is disclosed a user equipment (UE) for a communication system, the UE comprising: a controller and a transceiver, wherein the controller is configured to: control the transceiver to provide, to a node of a non-terrestrial network (NTN) access network, UE capability information comprising a capability indication for indicating a polarization capability of the UE, the capability indication for indicating a polarization capability being configurable for indicating the polarization capability to be any one of: a linear polarization capability; a right-hand circular polarization capability; a left-hand circular polarization capability; and both a right-hand circular polarization capability and a left-hand circular polarization capability.

In one example described herein there is disclosed an access network node for a communication system, the access network node comprising: a controller and a transceiver, wherein the controller is configured to: control the transceiver to provide, to a user equipment (UE), information for identifying an initial bandwidth part for communication between the UE and the access network in a first part of a communication coverage area provided by the access network, and information for identifying a set of one or more bandwidth parts, each bandwidth part of the set of bandwidth parts respectively being for potential future communication between the UE and the access network in a corresponding further part of the communication coverage area. The controller may be configured to identify a next bandwidth part of the set of bandwidth parts, for the UE to switch to from the initial bandwidth part as a position of the UE relative to the communication coverage area enters, or is approaching, the further part of the communication coverage area corresponding to the identified next bandwidth part. The controller may be configured to identify when the UE has switched to the identified next bandwidth part.

In one example described herein there is disclosed a node for a non-terrestrial network (NTN) access network, the node comprising: a controller and a transceiver, wherein the controller is configured to: control the transceiver to provide, to a user equipment (UE), information identifying at least one polarization employed by the NTN access network for communication in at least part of a communication coverage area provided by the NTN access network; control the transceiver to communicate with the UE based on the at least one polarization employed by the access network; and control the transceiver to provide, to the UE, ephemeris information for a satellite of the NTN access network, wherein updates to the ephemeris information are provided at a first periodicity; wherein updates to the information identifying at least one polarization employed by the access network are provided at a second periodicity corresponding to the first periodicity at which the updates to the ephemeris information are provided.

In one example described herein there is disclosed a node for a non-terrestrial network (NTN) access network, the node comprising: a controller and a transceiver, wherein the controller is configured to: control the transceiver to receive, from a UE, UE capability information comprising a capability indication for indicating a polarization capability of the UE, the capability indication for indicating a polarization capability being configurable for indicating the polarization capability to be any one of: a linear polarization capability; a right-hand circular polarization capability; a left-hand circular polarization capability; and both a right-hand circular polarization capability and a left-hand circular polarization capability.

Various other modifications will be apparent to those skilled in the art and will not be described in further detail here.

The whole or part of the exemplary embodiments disclosed above can be described as, but not limited to, the following supplementary notes.

### (Supplementary Note 1)

A method performed by a user equipment (UE) in a communication system, the method comprising:
receiving, from a node of an access network, information for identifying an initial bandwidth part corresponding to a first part of a communication coverage area provided by the access network;
receiving, from the node of the access network, information for identifying a set of one or more bandwidth parts, each bandwidth part of the set of the one or more bandwidth parts respectively corresponding to a corresponding further part of the communication coverage area;
identifying a next bandwidth part from the set of the one or more bandwidth parts, for switching from the initial bandwidth part, based on a position of the UE relative to the communication coverage area, or upon approaching the corresponding further part of the communication coverage area corresponding to the next bandwidth part; and
switching to the next bandwidth part.

### (Supplementary Note 2)

The method according to Supplementary Note 1, wherein the switching occurs when a timer expires.

### (Supplementary Note 3)

The method according to Supplementary Note 2, wherein the timer is a bandwidth part inactivity timer.

### (Supplementary Note 4)

The method according to any one of Supplementary Notes 1 to 3, wherein the identifying is determined based on a mapping between the set of the one or more bandwidth parts and a current location of the UE.

### (Supplementary Note 5)

The method according to any one of Supplementary Notes 1 to 4, wherein the switching is initiated by the UE autonomously.

### (Supplementary Note 6)

The method according to any one of Supplementary Notes 1 to 5, further comprising:
receiving measurement configuration information for configuring a measurement procedure to be performed by the UE for at least one beam in respect of which the next bandwidth part is to be used; and
performing the measurement procedure for the next bandwidth part based on the measurement configuration information, wherein
the switching is performed based on a result of measurement procedure for the next bandwidth part.

### (Supplementary Note 7)

The method according to Supplementary Note 6, wherein
the measurement configuration information includes criterion information for configuring at least one criterion for triggering transmission of a measurement report, and
the switching is performed upon the transmission of the measurement report.

### (Supplementary Note 8)

The method according to Supplementary Note 7, wherein
the criterion information includes information defining a threshold, and
the transmission of the measurement report is triggered in a case where a measurement value for the at least one beam in respect of which the next bandwidth part is to be used exceeds, or is no less than, the threshold.

### (Supplementary Note 9)

The method according to Supplementary Note 7 or 8, wherein
the criterion information includes information defining a measurement value delta, and
the transmission of the measurement report is triggered in a case where a difference between a measurement value for the at least one beam in respect of which the next bandwidth part is to be used and a measurement value for a beam in respect of which the initial bandwidth part is used, exceeds, or is no less than, the measurement value delta.

### (Supplementary Note 10)

The method according to any one of Supplementary Notes 7 to 9, wherein the switching is triggered autonomously by the UE, in a case where the at least one criterion for triggering transmission of a measurement report is satisfied, whereby the transmission of the measurement report serves as a notification, to the node of the access network, that the switching is triggered.

### (Supplementary Note 11)

The method according to any one of Supplementary Notes 1 to 10, wherein the position of the UE relative to the communication coverage area changes as a result of movement of the communication coverage area relative to an Earth surface.

### (Supplementary Note 12)

The method according to any one of Supplementary Notes 1 to 11, wherein the access network is non-terrestrial network (NTN) access network.

### (Supplementary Note 13)

A method performed by a user equipment (UE) in a communication system, the method comprising:
receiving, from a node of a non-terrestrial network (NTN) access network, polarization information identifying at least one polarization employed by the NTN access network for communication; and
communicating with the NTN access network based on the polarization information.

### (Supplementary Note 14)

The method according to Supplementary Note 13, wherein the polarization information includes at least one polarization indication for at least one of:
downlink (DL) communication; and
uplink (UL) communication.

### (Supplementary Note 15)

The method according to Supplementary Note 13, wherein
the polarization information includes at least one polarization indication for downlink (DL) communication, and at least one polarization indication for uplink (UL) communication, and
the at least one polarization indication for DL communication and the at least one polarization indication for UL communication are grouped by DL and UL respectively.

### (Supplementary Note 16)

The method according to any one of Supplementary Notes 13 to 15, wherein
the NTN access network provides a communication coverage area using at least one beam, and
the polarization information includes a respective polarization indication for each one of the at least one beam.

### (Supplementary Note 17)

The method according to any one of Supplementary Notes 13 to 16, wherein the polarization information includes a two-bit binary indication.

### (Supplementary Note 18)

The method according to any one of Supplementary Notes 13 to 17, wherein the polarization information indicates at least one of: right-hand circular polarization, left-hand circular polarization, and linear polarization.

### (Supplementary Note 19)

The method according to any one of Supplementary Notes 13 to 18, further comprising:
receiving, from the node of the NTN access network, ephemeris information for a satellite of the NTN access network, wherein the ephemeris information is used by the UE for communication via the NTN access network;
receiving updates to the ephemeris information at a first periodicity; and
receiving updates to the polarization information at a second periodicity corresponding to the first periodicity.

### (Supplementary Note 20)

A method performed by a user equipment (UE) in a communication system, the method comprising:
providing, to a node of a non-terrestrial network (NTN) access network, UE capability information for indicating a polarization capability of the UE, wherein
the polarization capability is used for communication between the UE and the node of the NTN access network.

### (Supplementary Note 21)

The method according to Supplementary Note 19, wherein:
the polarization capability including at least one of:
   a right-hand circular polarization capability;
   a left-hand circular polarization capability;
   a linear polarization capability; and both a right-hand circular polarization capability and a left-hand circular polarization capability.

### (Supplementary Note 22)

A method performed by a node of an access network in a communication system, the method comprising:
providing a communication coverage area for a user equipment (UE);
providing, to the UE, information for identifying an initial bandwidth part corresponding to a first part of the communication coverage area;
providing, to the UE, information for identifying a set of one or more bandwidth parts, each bandwidth part of the set of the one or more bandwidth parts respectively corresponding to a corresponding further part of the communication coverage area;
identifying a next bandwidth part of the set of the one or more bandwidth parts, for the UE to switch from the initial bandwidth part, based on a position of the UE relative to the communication coverage area, or upon the UE approaching the further part of the communication coverage area corresponding to the next bandwidth part; and
identifying when the UE has switched to the next bandwidth part.

### (Supplementary Note 23)

A method performed by a node of a non-terrestrial network (NTN) access network in a communication system, the method comprising:
providing, to a user equipment (UE), polarization information identifying at least one polarization employed by the NTN access network; and
communicating with the UE based on the at least one polarization identified by the polarization information.

### (Supplementary Note 24)

A method performed by a node of a non-terrestrial network (NTN) access network in a communication system, the method comprising:
receiving, from a user equipment (UE), UE capability information for indicating a polarization capability of the UE, wherein
the polarization capability is used for communication between the UE and the node of the NTN access network.

### (Supplementary Note 25)

A user equipment (UE) for a communication system, the UE comprising:
a controller and a transceiver, wherein the controller is configured to:
   control the transceiver to receive, from a node of an access network, information for identifying an initial bandwidth part corresponding to a first part of a communication coverage area provided by the access network,
   control the transceiver to receive, from the node of the access network, information for identifying a set of one or more bandwidth parts, each bandwidth part of the set of the one or more bandwidth parts respectively corresponding to a corresponding further part of the communication coverage area;
   identify a next bandwidth part from the set of the one or more bandwidth parts, for switching from the initial bandwidth part, based on a position of the UE relative to the communication coverage area, or upon approaching the corresponding further part of the communication coverage area corresponding to the next bandwidth part; and
   switch to the next bandwidth part.

### (Supplementary Note 26)

A user equipment (UE) for a communication system, the UE comprising:
a controller and a transceiver, wherein the controller is configured to:
   control the transceiver to receive, from a node of a non-terrestrial network (NTN) access network, polarization information identifying at least one polarization employed by the NTN access network for communication; and
   control the transceiver to communicate with the NTN access network based on the polarization information.

### (Supplementary Note 27)

A user equipment (UE) for a communication system, the UE comprising:
a controller and a transceiver, wherein the controller is configured to:
   control the transceiver to provide, to a node of a non-terrestrial network (NTN) access network, UE capability information for indicating a polarization capability of the UE, wherein
   the polarization capability is used for communication between the UE and the node of the NTN access network.

### (Supplementary Note 28)

An access network node for a communication system, the access network node comprising:
a controller and a transceiver, wherein the controller is configured to: control the transceiver to provide a communication coverage area for a user equipment (UE),
   control the transceiver to provide, to the UE, information for identifying an initial bandwidth part corresponding to a first part of the communication coverage area,
   control the transceiver to provide, to the UE, information for identifying a set of one or more bandwidth parts, each bandwidth part of the set of the one or more bandwidth parts respectively corresponding to a corresponding further part of the communication coverage area;
   identify a next bandwidth part of the set of the one or more bandwidth parts, for the UE to switch from the initial bandwidth part, based on a position of the UE relative to the communication coverage area, or upon the UE approaching the further part of the communication coverage area corresponding to the next bandwidth part, and
   identify when the UE has switched to the next bandwidth part.

### (Supplementary Note 29)

A node for a non-terrestrial network (NTN) access network, the node comprising:
a controller and a transceiver, wherein the controller is configured to:
   control the transceiver to provide, to a user equipment (UE), polarization information identifying at least one polarization employed by the NTN access network; and
   control the transceiver to communicate with the UE based on the at least one polarization identified by the polarization information.

### (Supplementary Note 30)

A node for a non-terrestrial network (NTN) access network, the node comprising:
a controller and a transceiver, wherein the controller is configured to:
   control the transceiver to receive, from a user equipment (UE), UE capability information for indicating a polarization capability of the UE, wherein
   the polarization capability is used for communication between the UE and the node of the NTN access network.

This application is based upon and claims the benefit of priority from Great Britain Patent Application No. 2111337.8, filed on Aug. 5, 2021, the disclosure of which is incorporated herein in its entirety by reference.

### REFERENCE SIGNS LIST

1 mobile (cellular or wireless) communication system
3 user equipment (UE)
5 base station
7 core network
8 non-terrestrial network (NTN) radio access network (RAN)
9 gateway
11 non-terrestrial platform
20 external data network
31 transceiver circuitry
33 air interface
35 user interface
37 controller
39 memory
41 operating system
43 communications control module
45 BWP management module
46 measurement management module
47 UE capability information module
48 polarization determination module
49 ephemeris data management module
51 transceiver circuitry
53 air interface
55 network interface
57 controller
59 memory
61 operating system
63 communications control module
65 BWP management module
67 measurement management module
71 polarization management module
73 ephemeris data management module

What is claimed is:

1-30. (canceled)

31. A method performed by a user equipment (UE), the method comprising:
communicating with an access network node via a non-terrestrial network (NTN), using a first bandwidth part corresponding to a first coverage area;
receiving, from the access network node, a Radio Resource Control (RRC) message including information for identifying a set of one or more bandwidth parts, each bandwidth part of the set of the one or more bandwidth parts respectively corresponding to a corresponding further coverage area;
switching from the first bandwidth part to a next bandwidth part of the set of the one or more bandwidth parts, based on a location of the UE, or upon approaching the corresponding further coverage area corresponding to the next bandwidth part.

32. The method according to claim 31, further comprising:
receiving measurement configuration information for configuring a measurement procedure to be performed by the UE for at least one beam in respect of which the next bandwidth part is to be used; and
performing the measurement procedure for the next bandwidth part based on the measurement configuration information, wherein
the switching is performed based on a result of measurement procedure for the next bandwidth part.

33. The method according to claim 32, wherein
the measurement configuration information includes criterion information for configuring at least one criterion for triggering transmission of a measurement report, and
the switching is performed upon the transmission of the measurement report.

34. The method according to claim 33, wherein
the criterion information includes information defining a threshold, and
the transmission of the measurement report is triggered in a case where a measurement value for the at least one beam in respect of which the next bandwidth part is to be used exceeds, or is no less than, the threshold.

35. The method according to claim 33, wherein
the criterion information includes information defining a measurement value delta, and
the transmission of the measurement report is triggered in a case where a difference between a measurement value for the at least one beam in respect of which the next bandwidth part is to be used and a measurement value for a beam in respect of which the first bandwidth part is used, exceeds, or is no less than, the measurement value delta.

36. The method according to claim 33, wherein
the transmission of the measurement report serves as a notification, to the access network node, that the switching is triggered.

37. The method according to claim 31, wherein the location of the UE changes as a result of movement of the coverage area.

38. The method according to claim 31, wherein the switching occurs when a bandwidth part inactivity timer expires.

39. A method performed by an access network node, the method comprising:
communicating with a user equipment (UE) via a non-terrestrial network (NTN), using a first bandwidth part corresponding to a first coverage area;
transmitting, to the UE, a Radio Resource Control (RRC) message including information for identifying a set of one or more bandwidth parts, each bandwidth part of the set of the one or more bandwidth parts respectively corresponding to a corresponding further coverage area;
identifying a next bandwidth part of the set of the one or more bandwidth parts, for the UE to switch from the first bandwidth part, based on a location of the UE, or upon the UE approaching the further coverage area corresponding to the next bandwidth part.

40. A user equipment (UE) comprising:
at least one memory storing instructions; and
at least one processor configured to process the instructions to:
communicate, with an access network node via a non-terrestrial network (NTN), using a first bandwidth part corresponding to a first coverage area,
receive, from the access network node, a Radio Resource Control (RRC) message including information for identifying a set of one or more bandwidth parts, each bandwidth part of the set of the one or more bandwidth parts respectively corresponding to a corresponding further coverage area;
switch from the first bandwidth part to a next bandwidth part of the set of the one or more bandwidth parts, based on a location of the UE, or upon approaching the corresponding further area corresponding to the next bandwidth part.

41. An access network node comprising:
at least one memory storing instructions; and
at least one processor configured to process the instructions to:
communicate with a user equipment (UE) via a non-terrestrial network (NTN), using a first bandwidth part corresponding to a first coverage area;
transmit, to the UE, a Radio Resource Control (RRC) message including information for identifying a set of one or more bandwidth parts, each bandwidth part of the set of the one or more bandwidth parts respectively corresponding to a corresponding further coverage area;
identify a next bandwidth part of the set of the one or more bandwidth parts, for the UE to switch from the first bandwidth part, based on a location of the UE, or upon the UE approaching the further coverage area corresponding to the next bandwidth part.
